(19) United States
(12) Patent Application Publication
(10) Pub. No.: US 2024/0214165 A1
(43) Pub. Date: Jun. 27, 2024

(54) CHANNEL STATE INFORMATION (CSI) REPORTING FOR RADIO FREQUENCY (RF) SENSING

(71) Applicant: QUALCOMM INCORPORATED, San Diego, CA (US)

(72) Inventors: Simone MERLIN, San Diego, CA (US); Vikram KANDUKURI, Bangalore (IN); Xiaoxin ZHANG, Sunnyvale, CA (US); Shwetha Goravanahalli KEMPARAJU, Bangalore (IN)

(21) Appl. No.: 18/559,771

(22) PCT Filed: Jun. 3, 2022
(86) PCT No.: PCT/US2022/032244

§ 371 Date: Nov. 8, 2023

(30) Foreign Application Priority Data
Jul. 16, 2021 (IN) 202141032188

(51) Int. Cl. H04L 5/00; H04L 25/02

(52) U.S. Cl. CPC H04L 5/0057; H04L 5/005; H04L 25/022; H04L 25/0224

(57) ABSTRACT

This disclosure provides systems, methods and apparatus, including computer programs encoded on computer storage media, for reporting channel state information (CSI). In some implementations, a receiving device may acquire a set of channel frequency response (CFR) values associated with one or more sounding packets that are received from a transmitting device and may group the set of CFR values into multiple subsets according to a number of transmit antennas of the transmitting device, a number of receive antennas of the receiving device, or a number of tones spanning a bandwidth of the wireless channel. In such implementations, the receiving device may transmit one or more CSI report frames each carrying a respective subset of the CFR values. In some other implementations, a receiving device may acquire multiple CSI associated with respective sounding packets and may transmit a single CSI report frame carrying the CSI for each of the wireless channels.

### CROSS-REFERENCE TO RELATED APPLICATIONS

The present Application is a 371 national stage filing of International PCT Application No. PCT/US2022/032244 by Merlin et al. entitled “CHANNEL STATE INFORMATION (CSI) REPORTING FOR RADIO FREQUENCY (RF) SENSING,” filed Jun. 3, 2022; and claims priority to Indian Patent Application No. 202141032188 by Merlin et al. entitled “CHANNEL STATE INFORMATION (CSI) REPORTING FOR RADIO FREQUENCY (RF) SENSING,” filed Jul. 16, 2021, each of which is assigned to the assignee hereof, and each of which is expressly incorporated by reference in its entirety herein.

### TECHNICAL FIELD

This disclosure relates generally to radio frequency (RF) sensing, and more specifically, to channel state information (CSI) reporting techniques for RF sensing.

### DESCRIPTION OF THE RELATED TECHNOLOGY

Wireless communication devices communicate by transmitting and receiving electromagnetic signals in the radio frequency (RF) spectrum. The operating environment of the wireless communication devices affects the propagation of the electromagnetic signals. For example, electromagnetic signals transmitted by a transmitting device may reflect off objects and surfaces in the environment before reaching a receiving device located a distance away. Accordingly, the amplitudes or phases of the electromagnetic signals received by the receiving device may depend, at least in part, on the characteristics of the environment.

RF sensing is a technique for sensing objects or movement in an environment based, at least in part, on the transmission and reception of electromagnetic signals. More specifically, changes in the environment can be detected based on changes in the electromagnetic signals (such as phase or amplitude) propagating through the environment. For example, a person moving through the environment interferes with the electromagnetic signals that are transmitted by a transmitting device. A receiving device may detect and characterize such changes to its received signals to determine the speed or direction of the person's movement.

### SUMMARY

The systems, methods and devices of this disclosure each have several innovative aspects, no single one of which is solely responsible for the desirable attributes disclosed herein.

One innovative aspect of the subject matter described in this disclosure can be implemented as a method of wireless communication. The method can be performed by a wireless communication device to report channel state information (CSI) for a wireless channel. In some implementations, the method can include receiving one or more sounding packets, over a wireless channel, from a transmitting device: acquiring channel state information (CSI) associated with the one or more sounding packets, where the CSI includes a set of values grouped into a plurality of subsets according to a number (M) of transmit antennas of the transmitting device, a number (N) of receive antennas of the wireless communication device, or a number (K) of tones spanning a bandwidth of the wireless channel, where each of the values indicates a channel frequency response (CFR) associated with a respective one of the M transmit antennas, a respective one of the N receive antennas, and a respective one of the K tones: and transmitting one or more CSI report frames each carrying a respective subset of values of the plurality of subsets.

Another innovative aspect of the subject matter described in this disclosure can be implemented in a wireless communication device. The wireless communication device can include an interface configured to receive one or more sounding packets, over a wireless channel, from a transmitting device: and a processing system configured to acquire CSI associated with the one or more sounding packets, where the CSI includes a set of values grouped into a plurality of subsets according to a number (M) of transmit antennas of the transmitting device, a number (N) of receive antennas of the wireless communication device, or a number (K) of tones spanning a bandwidth of the wireless channel, where each of the values indicates a CFR associated with a respective one of the M transmit antennas, a respective one of the N receive antennas, and a respective one of the K tones: and where the interface is further configured to transmit one or more CSI report frames each carrying a respective subset of values of the plurality of subsets.

Another innovative aspect of the subject matter described in this disclosure can be implemented as a method of wireless communication. The method can be performed by a wireless communication device to report CSI for a wireless channel. In some implementations, the method can include receiving a first sounding packet over a first wireless channel: acquiring first CSI associated with the first sounding packet: receiving a second sounding packet over a second wireless channel: acquiring second CSI associated with the second sounding packet: and transmitting a CSI report frame including a first report field carrying the first CSI and a second report field carrying the second CSI.

Another innovative aspect of the subject matter described in this disclosure can be implemented in a wireless communication device. The wireless communication device can include an interface configured to receive a first sounding packet over a first wireless channel and to receive a second sounding packet over a second wireless channel: and a processing system configured to acquire first CSI associated with the first sounding packet and to acquire second CSI associated with the second sounding packet: and where the interface is further configured to transmit a CSI report frame including a first report field carrying the first CSI and a second report field carrying the second CSI.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless system.

FIG. 2 shows a block diagram of an example wireless station (STA).

FIG. 3 shows a block diagram of an example access point (AP).

FIGS. 4A and 4B shows an example radio frequency (RF) sensing system.

FIG. 5 shows an example channel state information (CSI) matrix.

FIGS. 6A-6E show example CSI matrices each including a set of channel frequency response (CFR) values grouped into multiple subsets.

FIG. 7 shows a sequence diagram depicting an example message exchange between devices participating in a channel sounding operation.

FIG. 8 shows a sequence diagram depicting an example message exchange between devices participating in a channel sounding operation.

FIG. 9 shows a sequence diagram depicting an example message exchange between devices participating in a channel sounding operation.

FIG. 10 shows a sequence diagram depicting an example message exchange between devices participating in a channel sounding operation.

FIG. 11 shows an example CSI report frame for multiple captures.

FIG. 12 shows an example CSI report frame for multiple captures.

FIG. 13 shows an example CSI report frame for multiple captures.

FIG. 14 shows an illustrative flowchart depicting an example wireless communication operation.

FIG. 15 shows an illustrative flowchart depicting an example wireless communication operation.

FIG. 16 shows a block diagram of an example wireless communication device.

FIG. 17 shows a block diagram of an example wireless communication device.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Long Term Evolution (LTE), 3G, 4G or 5G (New Radio (NR)) standards promulgated by the 3rd Generation Partnership Project (3GPP), the Institute of Electrical and Electronics Engineers (IEEE) 802.11 standards, the IEEE 802.15 standards, or the Bluetooth® standards as defined by the Bluetooth Special Interest Group (SIG), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless wide area network (WWAN), a wireless personal area network (WPAN), a wireless local area network (WLAN), or an internet of things (IOT) network.

Existing versions of the IEEE 802.11 standard provide a channel sounding procedure for capturing or acquiring channel state information (CSI). CSI describes how signals propagate through a wireless channel between a transmitting device and a receiving device. As such, CSI may be well-suited for radio frequency (RF) sensing applications. The CSI is often represented by a three-dimensional matrix, where each entry in the matrix indicates a channel frequency response (CFR) associated with a respective transmit antenna of the transmitting device, a respective receive antenna of the receiving device, and a respective tone or subcarrier of the wireless channel. However, this level of detail may not be necessary for some RF sensing applications.

A channel sounding procedure may be performed by a transmitting (TX) device transmitting a known pattern or sequence of signals, over a wireless channel, to a receiving (RX) device, which captures or acquires CSI based on the received signals. More specifically, the RX device may compare the received signals with the known pattern or sequence to determine the effects of the wireless channel on the propagation of the signals. Thus, the CSI may be a matrix representation of the wireless channel, where each entry in the matrix indicates a CFR for a respective tone or subcarrier of the wireless channel, between a respective transmit antenna of the TX device and a respective receive antenna of the RX device. Accordingly, each entry in the CSI matrix may be referred to herein as a “CFR value.” In some instances, a channel sounding “responder” (which may be the RX device or another device operating in conjunction with the RX device) may report the captured CSI to a channel sounding “initiator” (which may be the TX device or another device operating in conjunction with the TX device) via a management frame.

The size of the CSI depends on the bandwidth of the wireless channel and the number of antennas used to transmit and receive the wireless signals. However, the payload size of a management frame is capped at 11,454 bytes. CSI that exceeds the maximum payload size of a management frame can be segmented for transmission in multiple management frames. According to existing versions of the IEEE 802.11 standard (such as the IEEE 802.11ax amendment), each segment must be 11,454 bytes long except the last segment (which can be smaller). As such, each management frame may not carry a well-defined (or delineated) subset of CFR values. In other words, the initiator must receive every segment before it can interpret the CSI associated therewith. However, aspects of the present disclosure recognize that a comprehensive CSI report may not be necessary for some RF sensing applications. For example, the presence or movement of an object can be detected based on changes to the wireless channel. Such changes can be detected in any tone (or subset of tones) spanning the bandwidth of the wireless channel and for any combination of transmit and receive antennas. Accordingly, new CSI reporting techniques are needed for RF sensing.

Implementations of the subject matter described in this disclosure may be used to report CSI for RF sensing applications. In some aspects, an RX device may acquire a set of CFR values (representing CSI) associated with one or more sounding packets that are received, over a wireless channel, from a TX device, and may group the set of CFR values into multiple subsets according to a number (M) of transmit antennas of the TX device, a number (N) of receive antennas of the RX device, or a number (K) of tones spanning a bandwidth of the wireless channel. Accordingly, the RX device may transmit one or more CSI report frames each carrying a respective subset of the CFR values. In some implementations, each subset of CFR values may be associated with a respective subset of the K tones, a respective subset of the M transmit antennas, or a respective subset of the N receive antennas. In some other implementations, a first component of one or more CFR values (such as an amplitude component or an in-phase (I) component) may be grouped into different subsets than a second component of the one or more CFR values (such as a phase component or a quadrature (Q) component).

In some other aspects, an RX device may acquire multiple CSI associated with respective sounding packets received over multiple wireless channels and may transmit a single CSI report frame carrying the CSI for each of the wireless channels. For example, each CSI may be carried in a respective report field of the CSI report frame. In some implementations, the CSI report frame may further include multiple control fields each carrying metadata associated with the CSI for a respective wireless channel. In some implementations, the control and report fields associated with a given wireless channel may be included in the same information element (IE) within a frame body of the CSI report frame. In some other implementations, each report field may follow immediately after a respective control field in a frame body of the CSI report frame. In such implementations, each control field may further carry length information indicating a length of the following report field. Still further, in some implementations, delimiters may be added to a frame body of the CSI report frame to signal the start (or end) of each pair of control and report fields.

Particular implementations of the subject matter described in this disclosure can be implemented to realize one or more of the following potential advantages. By grouping CFR values into multiple subsets, aspects of the present disclosure may allow efficient reporting of CSI for RF sensing applications. For example, the size of each subset of CFR values may be suitable for transmission in a single management frame. Unlike the segmentation techniques defined by existing versions of the IEEE 802.11 standard, each CSI report frame of the present implementations may include a well-defined subset of CFR values. As a result, an initiator may perform at least part of an RF sensing operation responsive to each CSI report frame received from the RX device (without having to receive every CSI report frame associated with a given wireless channel). By including multiple CSI in a single CSI report frame, aspects of the present disclosure may further reduce the signaling overhead associated with CSI reporting. For example, each CSI carried in the CSI report may be associated with a different wireless channel. As such, the initiator may perform RF sensing in multiple wireless channels responsive to a single CSI report frame.

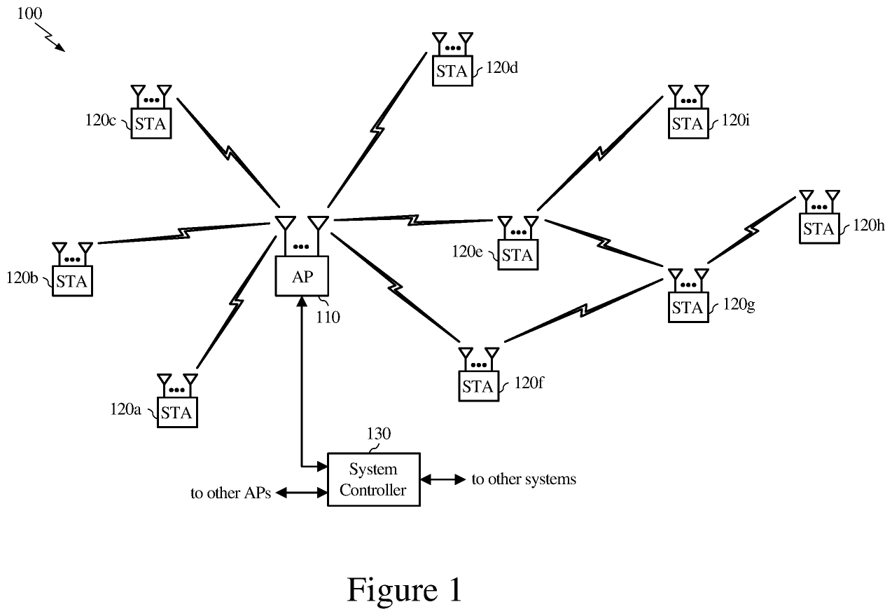

FIG. 1 shows a block diagram of an example wireless system 100. The wireless system 100 is shown to include a wireless access point (AP) 110 and a number of wireless stations (STAs) 120a-120i. For simplicity, one AP 110 is shown in FIG. 1. The AP 110 may form a wireless local area network (WLAN) that allows the AP 110, the STAs 120a-120i, and other wireless devices (not shown for simplicity) to communicate with each other over a wireless medium. The wireless medium, which may be divided into a number of channels or into a number of resource units (RUS), may facilitate wireless communications between the AP 110, the STAs 120a-120i, and other wireless devices connected to the WLAN. In some implementations, the STAs 120a-120i can communicate with each other using peer-to-peer communications (such as without the presence or involvement of the AP 110). The AP 110 may be assigned a unique MAC address that is programmed therein by, for example, the manufacturer of the access point. Similarly, each of the STAs 120a-120i also may be assigned a unique MAC address.

In some implementations, the wireless system 100 may correspond to a multiple-input multiple-output (MIMO) wireless network and may support single-user MIMO (SU-MIMO) and multi-user (MU-MIMO) communications. In some implementations, the wireless system 100 may support orthogonal frequency-division multiple access (OFDMA) communications. Further, although the WLAN is depicted in FIG. 1 as an infrastructure Basic Service Set (BSS), in some other implementations, the WLAN may be an Independent Basic Service Set (IBSS), an Extended Service Set (ESS), an ad-hoc network, or a peer-to-peer (P2P) network (such as operating according to one or more Wi-Fi Direct protocols).

The STAs 120a-120i may be any suitable Wi-Fi enabled wireless devices including, for example, cell phones, personal digital assistants (PDAs), tablet devices, laptop computers, or the like. The STAs 120a-120i also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The AP 110 may be any suitable device that allows one or more wireless devices (such as the STAs 120a-120i) to connect to another network (such as a local area network (LAN), wide area network (WAN), metropolitan area network (MAN), or the Internet). In some implementations, a system controller 130 may facilitate communications between the AP 110 and other networks or systems. In some implementations, the system controller 130 may facilitate communications between the AP 110 and one or more other APs (not shown for simplicity) that may be associated with other wireless networks. In addition, or in the alternative, the AP 110 may exchange signals and information with one or more other APs using wireless communications.

The AP 110 may periodically broadcast beacon frames to enable the STAs 120a-120i and other wireless devices within wireless range of the AP 110 to establish and maintain a communication link with the AP 110. The beacon frames, which may indicate downlink (DL) data transmissions to the STAs 120a-120i and solicit or schedule uplink (UL) data transmissions from the STAs 120a-120i, are typically broadcast according to a target beacon transmission time (TBTT) schedule. The broadcasted beacon frames may include a timing synchronization function (TSF) value of the AP 110. The STAs 120a-120i may synchronize their own local TSF values with the broadcasted TSF value, for example, so that all of the STAs 120a-120i are synchronized with each other and with the AP 110.

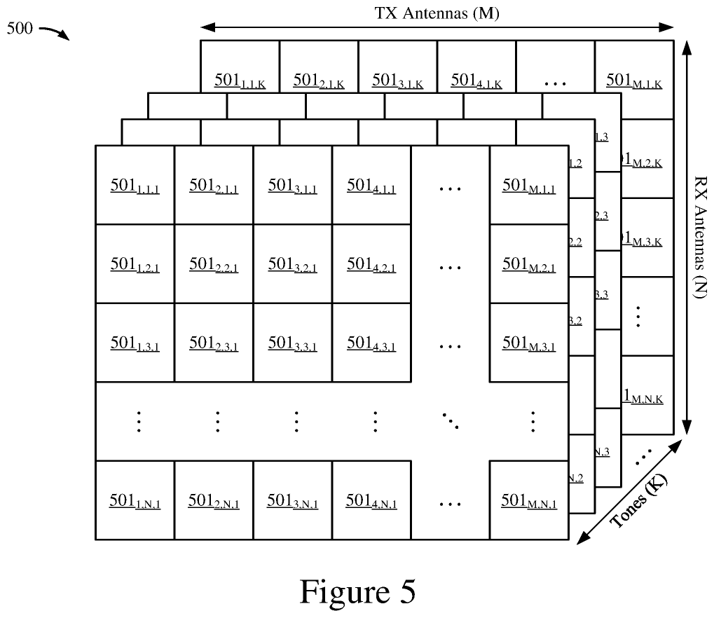

In some implementations, each of the stations STAs 120a-120i and the AP 110 may include one or more transceivers, one or more processing resources (such as processors or Application-Specific Integrated Circuits (ASICs)), one or more memory resources, and a power source (such as a battery). The one or more transceivers may include Wi-Fi transceivers, Bluetooth transceivers, cellular transceivers, or other suitable radio frequency (RF) transceivers (not shown for simplicity) to transmit and receive wireless communication signals. In some implementations, each transceiver may communicate with other wireless devices in distinct frequency bands or using distinct communication protocols. The memory resources may include a non-transitory computer-readable medium (such as one or more nonvolatile memory elements, such as EPROM, EEPROM, Flash memory, a hard drive, etc.) that stores instructions for performing one or more operations described with respect to FIGS. 5-11.

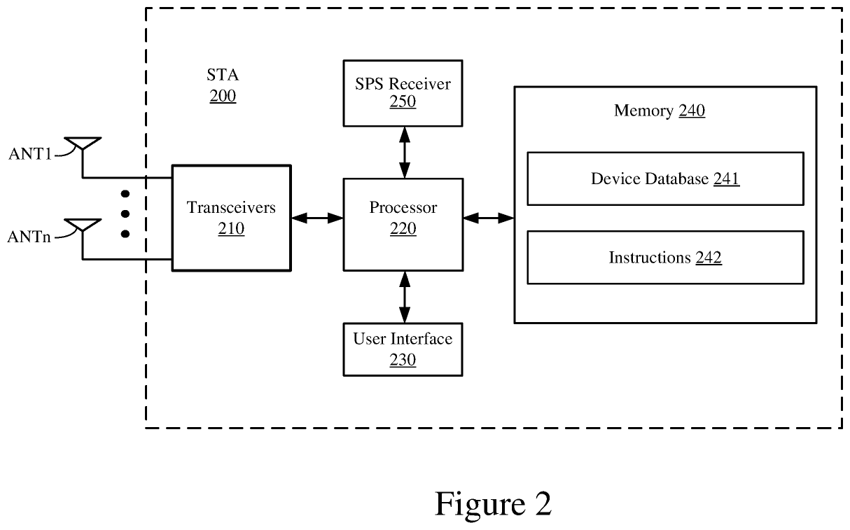

FIG. 2 shows an example wireless station (STA) 200. The STA 200 may be one implementation of at least one of the STAs 120a-120i of FIG. 1. The STA 200 may include one or more transceivers 210, a processor 220, a user interface 230, a memory 240, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals from other wireless devices including, for example, a number of APs and a number of other STAs. Although not shown in FIG. 2 for simplicity, the transceivers 210 may include any number of transmit chains to process and transmit signals to other wireless devices via antennas ANT1-ANTn, and may include any number of receive chains to process signals received from antennas ANT1-ANTn. Thus, the STA 200 may be configured for MIMO communications and OFDMA communications. The MIMO communications may include SU-MIMO communications and MU-MIMO communications. In some implementations, the STA 200 may use multiple antennas ANT1-ANTn to provide antenna diversity. Antenna diversity may include polarization diversity, pattern diversity, and spatial diversity.

The processor 220 may be any suitable one or more processors capable of executing scripts or instructions of one or more software programs stored in the STA 200 (such as within the memory 240). In some implementations, the processor 220 may be or include one or more microprocessors providing the processor functionality and external memory providing at least a portion of machine-readable media. In other implementations, the processor 220 may be or include an Application Specific Integrated Circuit (ASIC) with the processor, the bus interface, the user interface, and at least a portion of the machine-readable media integrated into a single chip. In some other implementations, the processor 220 may be or include one or more Field Programmable Gate Arrays (FPGAs) or Programmable Logic Devices (PLDs).

In some implementations, the processor 220 may be a component of a processing system. A processing system may generally refer to a system or series of machines or components that receives inputs and processes the inputs to produce a set of outputs (which may be passed to other systems or components of, for example, the STA 200). For example, a processing system of the STA 200 may refer to a system including the various other components or subcomponents of the STA 200.

The processing system of the STA 200 may interface with other components of the STA 200, and may process information received from other components (such as inputs or signals), output information to other components, and the like. For example, a chip or modem of the STA 200 may be coupled to or include a processing system, a first interface to output information, and a second interface to obtain information. In some instances, the first interface may refer to an interface between the processing system of the chip or modem and a transmitter, such that the STA 200 may transmit information output from the chip or modem. In some instances, the second interface may refer to an interface between the processing system of the chip or modem and a receiver, such that the STA 200 may obtain information or signal inputs, and the information may be passed to the processing system. A person having ordinary skill in the art will readily recognize that the first interface also may obtain information or signal inputs, and the second interface also may output information or signal outputs.

The user interface 230, which is coupled to the processor 220, may be or represent a number of suitable user input devices such as, for example, a speaker, a microphone, a display device, a keyboard, a touch screen, and so on. In some implementations, the user interface 230 may allow a user to control a number of operations of the STA 200, to interact with one or more applications executable by the STA 200, and other suitable functions.

In some implementations, the STA 200 may include a satellite positioning system (SPS) receiver 250. The SPS receiver 250, which is coupled to the processor 220, may be used to acquire and receive signals transmitted from one or more satellites or satellite systems via an antenna (not shown for simplicity). Signals received by the SPS receiver 250 may be used to determine (or at least assist with the determination of) a location of the STA 200.

The memory 240 may include a device database 241 that may store location data, configuration information, data rates, a medium access control (MAC) address, timing information, modulation and coding schemes (MCSs), traffic indication (TID) queue sizes, ranging capabilities, and other suitable information about (or pertaining to) the STA 200. The device database 241 also may store profile information for a number of other wireless devices. The profile information for a given wireless device may include, for example, a service set identification (SSID) for the wireless device, a Basic Service Set Identifier (BSSID), operating channels, TSF values, beacon intervals, ranging schedules, channel state information (CSI), received signal strength indicator (RSSI) values, goodput values, and connection history with the STA 200. In some implementations, the profile information for a given wireless device also may include clock offset values, carrier frequency offset values, and ranging capabilities.

The memory 240 also may be or include a non-transitory computer-readable storage medium (such as one or more nonvolatile memory elements, such as EPROM, EEPROM, Flash memory, a hard drive, and so on) that may store computer-executable instructions 242 to perform all or a portion of one or more operations described in this disclosure.

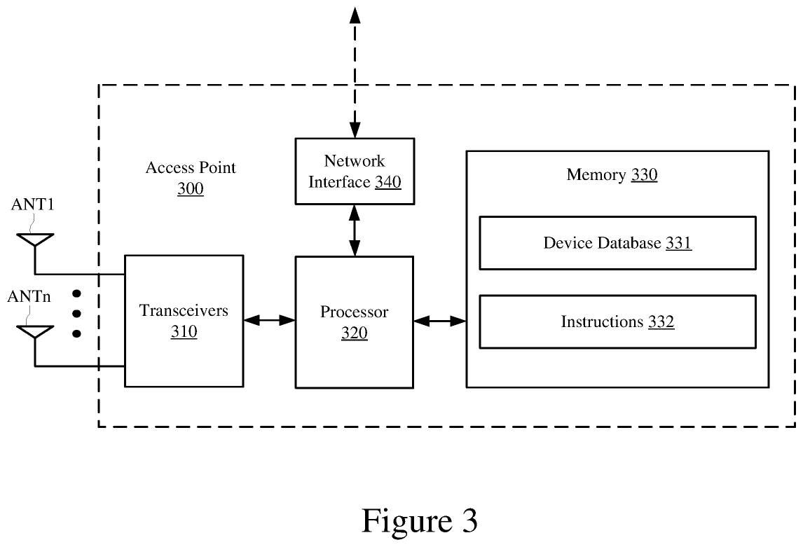

FIG. 3 shows an example access point (AP) 300. The AP 300 may be one implementation of the AP 110 of FIG. 1. The AP 300 may include one or more transceivers 310, a processor 320, a memory 330, a network interface 340, and a number of antennas ANTI-ANTn. The transceivers 310 may be coupled to the antennas ANTI-ANTn, either directly or through an antenna selection circuit (not shown for simplicity). The transceivers 310 may be used to transmit signals to and receive signals from other wireless devices including, for example, one or more of the STAs 120a-120i of FIG. 1 and other APs. Although not shown in FIG. 3 for simplicity, the transceivers 310 may include any number of transmit chains to process and transmit signals to other wireless devices via the antennas ANTI-ANTn, and may include any number of receive chains to process signals received from the antennas ANTI-ANTn. Thus, the AP 300 may be configured for MIMO communications and OFDMA communications. The MIMO communications may include SU-MIMO communications and MU-MIMO communications. In some implementations, the AP 300 may use multiple antennas ANTI-ANTn to provide antenna diversity. Antenna diversity may include polarization diversity, pattern diversity, and spatial diversity.

In high frequency (such as 60 GHz or millimeter wave (mmWave)) wireless communication systems (such as conforming to the IEEE 802.1lad or 802.11ay amendments of the IEEE 802.11 standard), communications may be beamformed using phased array antennas at the transmitter and the receiver. Beamforming generally refers to a wireless communication technique by which the transmitting device and the receiving device adjust transmit or receive antenna settings to achieve a desired link budget for subsequent communications. The procedure to adapt the transmit and receive antennas, referred to as beamforming training, may be performed initially to establish a link between the transmitting and receiving devices and also may be performed periodically to maintain a quality link using optimized transmit and receive beams.

The processor 320 may be any suitable one or more processors capable of executing scripts or instructions of one or more software programs stored in the AP 300 (such as within the memory 330). In some implementations, the processor 320 may be or include one or more microprocessors providing the processor functionality and external memory providing at least a portion of machine-readable media. In other implementations, the processor 320 may be or include an ASIC with the processor, the bus interface, the user interface, and at least a portion of the machine-readable media integrated into a single chip. In some other implementations, the processor 320 may be or include one or more FPGAs or PLDs. In some implementations, the processor 320 may be a component of a processing system. For example, a processing system of the AP 300 may refer to a system including the various other components or subcomponents of the AP 300.

The processing system of the AP 300 may interface with other components of the AP 300, and may process information received from other components (such as inputs or signals), output information to other components, and the like. For example, a chip or modem of the AP 300 may include a processing system, a first interface to output information, and a second interface to obtain information. In some instances, the first interface may refer to an interface between the processing system of the chip or modem and a transmitter, such that the AP 300 may transmit information output from the chip or modem. In some instances, the second interface may refer to an interface between the processing system of the chip or modem and a receiver, such that the AP 300 may obtain information or signal inputs, and the information may be passed to the processing system. A person having ordinary skill in the art will readily recognize that the first interface also may obtain information or signal inputs, and the second interface also may output information or signal outputs.

The network interface 340, which is coupled to the processor 320, may be used to communicate with the system controller 130 of FIG. 1. The network interface 340) also may allow the AP 300 to communicate, either directly or via one or more intervening networks, with other wireless systems, with other APs, with one or more back-haul networks, or any combination thereof.

The memory 330 may include a device database 331 that may store location data, configuration information, data rates, the MAC address, timing information, MCSs, ranging capabilities, and other suitable information about (or pertaining to) the AP 300. The device database 331 also may store profile information for a number of other wireless devices (such as one or more of the stations 120a-120i of FIG. 1). The profile information for a given wireless device may include, for example, an SSID for the wireless device, a BSSID, operating channels, CSI, received signal strength indicator (RSSI) values, goodput values, and connection history with the AP 300. In some implementations, the profile information for a given wireless device also may include TID queue sizes, a preferred packet duration for trigger-based UL transmissions, and a maximum amount of queued UL data that the wireless device is able to insert into TB PPBUs.

The memory 330 also may be or include a non-transitory computer-readable storage medium (such as one or more nonvolatile memory elements, such as EPROM, EEPROM, Flash memory, a hard drive, and so on) that may store computer-executable instructions 332 to perform all or a portion of one or more operations described in this disclosure.

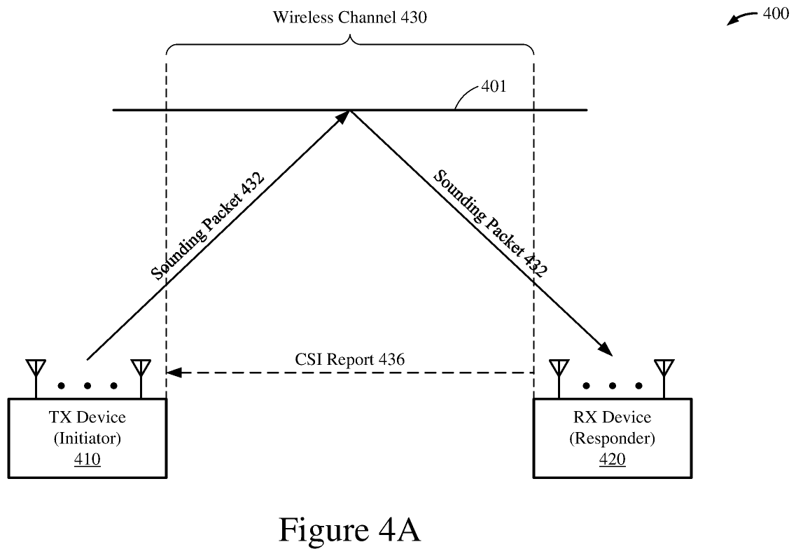

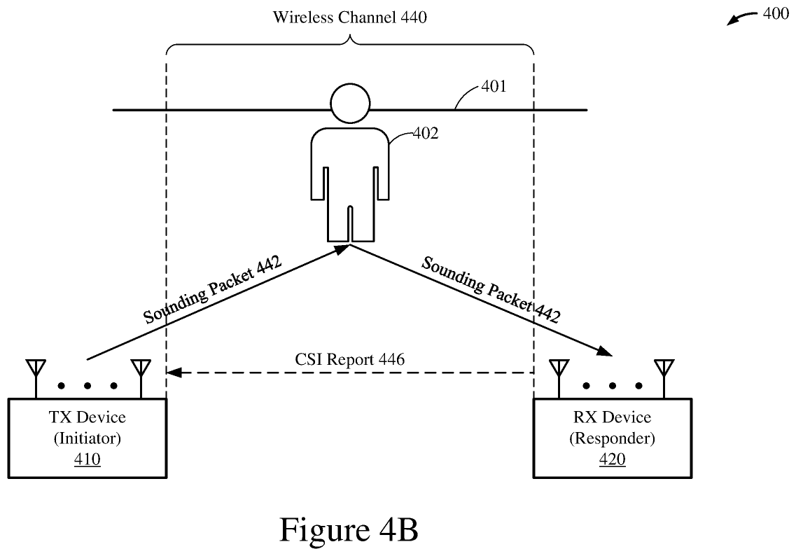

FIGS. 4A and 4B shows an example RF sensing system 400. The RF sensing system 400 includes a TX device 410 and an RX device 420. In some implementations, the TX device 410 may be one example of the AP 110 of FIG. 1 or the AP 300 of FIG. 3. In some other implementations, the TX device 410 may be one example of any of the STAs 120 of FIG. 1 or the STA 200 of FIG. 2. In some implementations, the RX device 420 may be one example of the AP 110 of FIG. 1 or the AP 300 of FIG. 3. In some other implementations, the RX device 420 may be one example of any of the STAs 120 of FIG. 1 or the STA 200 of FIG. 2. In the example of FIGS. 4A and 4B, the TX device 410 is an initiator of a channel sounding operation and the RX device 420 is a responder of the channel sounding operation.

With reference to FIG. 4A, the TX device 410 may initiate a channel sounding operation by transmitting a sounding packet 432, over a wireless channel 430, to the RX device 420. In some implementations, the sounding packet 432 may be a null data packet (NDP) that includes a known pattern or sequence of training signals, for example, in one or more long training fields (LTFs). Some training signals may reflect off objects or surfaces in the environment. As shown in FIG. 4A, a static object or surface 401 (such as a wall) reflects the sounding packet 432 in a direction of the RX device 420. The RX device 420 receives the sounding packet 432 and may capture or acquire CSI, associated with the wireless channel 430, by comparing the training signals (v) in the received sounding packet 432 with their known values (x). The CSI indicates how the wireless channel 430 affects the propagation of signals transmitted by the TX device 410 to the RX device 420. Thus, the CSI can be modeled as a matrix (H), where y=H*x. In some implementations, the RX device 420 may transmit a CSI report 436, including the CSI associated with the wireless channel 430, back to the TX device 410.

With reference to FIG. 4B, a new object 402 (such as a person) may enter the environment of the RF sensing system 400. The TX device 410 may transmit another sounding packet 442, in the presence of the object 402, to the RX device 420. The RX device 420 receives the sounding packet 442 and may capture or acquire CSI, associated with the wireless channel 440, by comparing the training signals in the received sounding packet 442 with their known values. In comparison to FIG. 4A, the new object 402 may alter the propagation of at least some of the signals transmitted by the TX device 410 to the RX device 420. For example, the phases or amplitudes of training signals received (by the RX device 420) in the presence of the object 402 may be different than the phases or amplitudes of training signals received in the absence of the object 402. As a result, the wireless channel 440 may be different than the wireless channel 430 previously measured by the RX device 420. In some implementations, the RX device 420 may transmit a CSI report 446, including the CSI associated with the wireless channel 440), back to the TX device 410.

The TX device 410 may perform an RF sensing operation based on changes or differences between the wireless channels 430 and 440. Example suitable RF sensing operations may include object detection, movement detection, movement classification (such as walking, falling, or gestures), object tracking (such as movement direction, range, or location), and vital sign monitoring (such as breathing). The TX device 410) may detect such changes between the wireless channels 430 and 440 by comparing the CSI associated with the wireless channel 440 (carried in the channel report 446) with the CSI associated with the wireless channel 430 (carried in the channel report 436). Assuming the TX device 410 and the RX device 420 remain relatively static during the channel sounding operation (such as from FIG. 4A to FIG. 4B), the differences between wireless channels 430 and 440 may be attributed to the presence or movement of the new object 402.

FIG. 5 shows an example CSI matrix 500. With reference for example to FIGS. 4A and 4B, the CSI matrix 500 may be one example of the CSI associated with any of the wireless channels 430 or 440, as acquired by the RX device 420. As shown in FIG. 5, the CSI matrix 500 is a three-dimensional matrix of CFR values 501 spanning a number (M) of transmit (TX) antennas used to transmit the training signals, a number (N) of receive (RX) antennas used to receive the training signals, and a number (K) of tones spanning a bandwidth of the wireless channel. Each of the CFR values 501 may be a complex number having in-phase and quadrature components or amplitude and phase components. More specifically, CFR value 501_{i,j,q} represents the channel frequency response associated with the i^{th} TX antenna (for 1≤i≤M), the j^{th} RX antenna (for 1≤j≤N), and the q^{th} tone (for 1≤q≤K). Accordingly, the size of the CSI matrix 500 depends on the bandwidth of the wireless channel and the number of antennas used to transmit and receive the training signals.

In some implementations, each CSI report may be carried in a management frame (such as an action frame). As such, any CSI larger than the payload of a management frame (>11,454 bytes) must be transmitted in multiple management frames. Aspects of the present disclosure recognize that some RF sensing applications may not require a complete or comprehensive CSI report. In other words, a TX device or initiator may not need to receive all the CFR values 501_{1,1,1}-501_{M,N,K} of the CSI matrix 500 to perform one or more RF sensing operations. For example, the TX device or initiator can detect a presence or movement of an object in its surrounding environment based on changes in a wireless channel. Such changes can be detected in any tone (or subset of tones) spanning the bandwidth of the wireless channel, for any combination of TX and RX antennas. Moreover, such changes can be detected in any component of the channel frequency response such as, for example, the in-phase component, the quadrature component, the amplitude component, or the phase component of each CFR value 501.

In some aspects, an RX device or responder may group the CFR values 501_{1,1,1}-501_{M,N,K} into multiple subsets for transmission in multiple CFR reports, respectively. More specifically, the CFR values 501 may be grouped in such a manner as to allow one or more RF sensing operations to be performed by a TX device or initiator responsive to each CFR report. In some implementations, the CFR values 501 may be grouped according to the K tones so that CFR values 501 associated with the same subset of tones are grouped into the same subset of CFR values. In some other implementations, the CFR values 501 may be grouped according to the M TX antennas so that CFR values 501 associated with the same subset of TX antennas are grouped into the same subset of CFR values. In some implementations, the CFR values 501 may be grouped according to the N RX antennas so that CFR values 501 associated with the same subset of RX antennas are grouped into the same subset of CFR values. Still further, in some implementations, portions of each CFR value 501 may be grouped into different subsets so that at least one subset includes the I or amplitude components of one or more CFR values 501 and another subset includes the Q or phase components of the one or more CFR values 501.

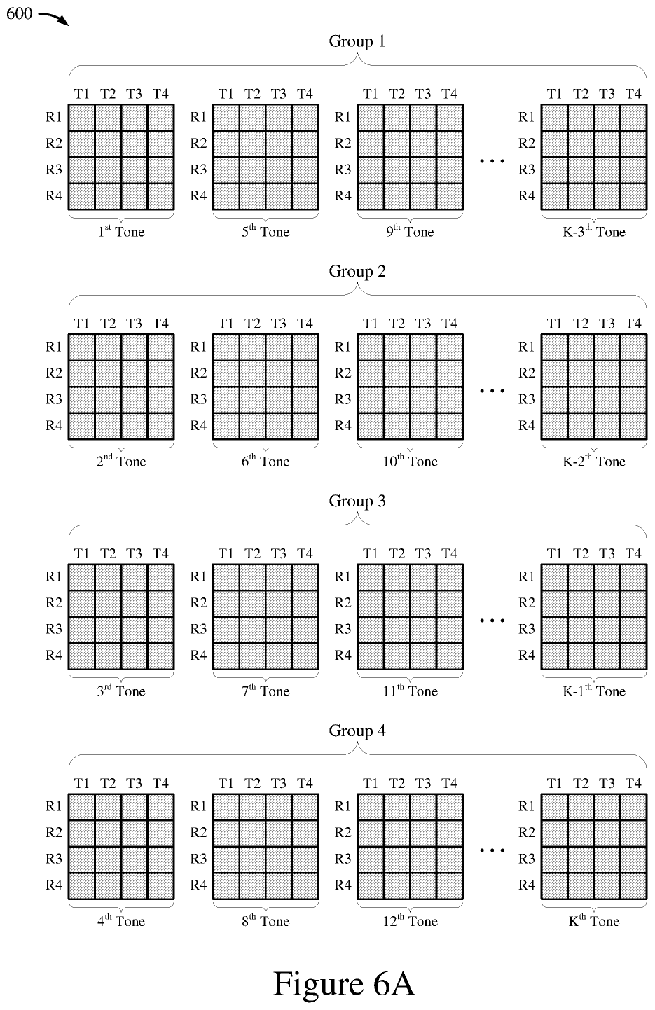

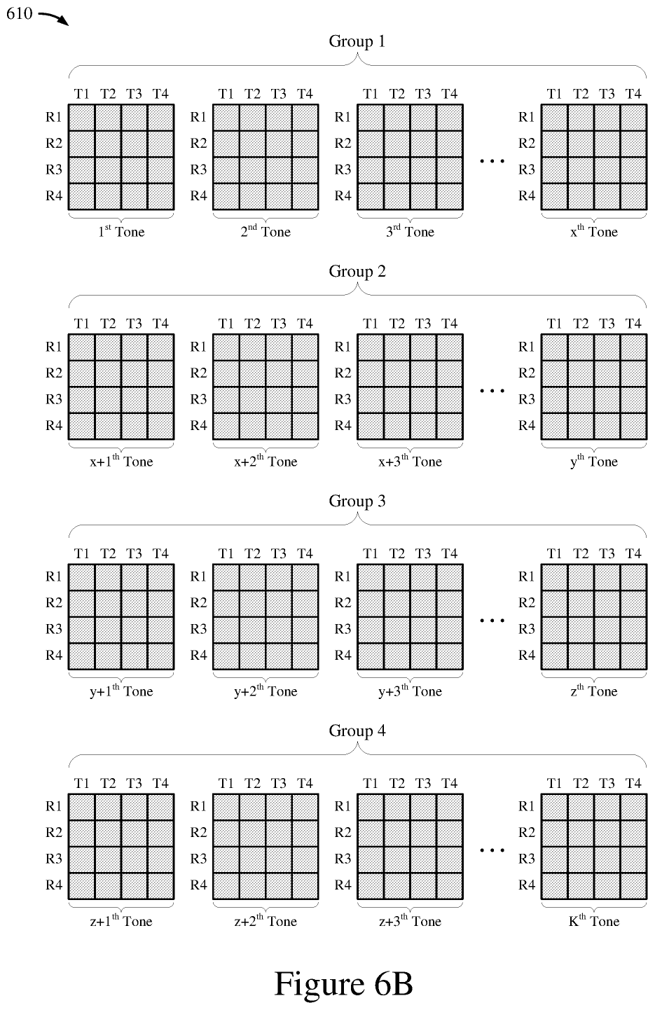

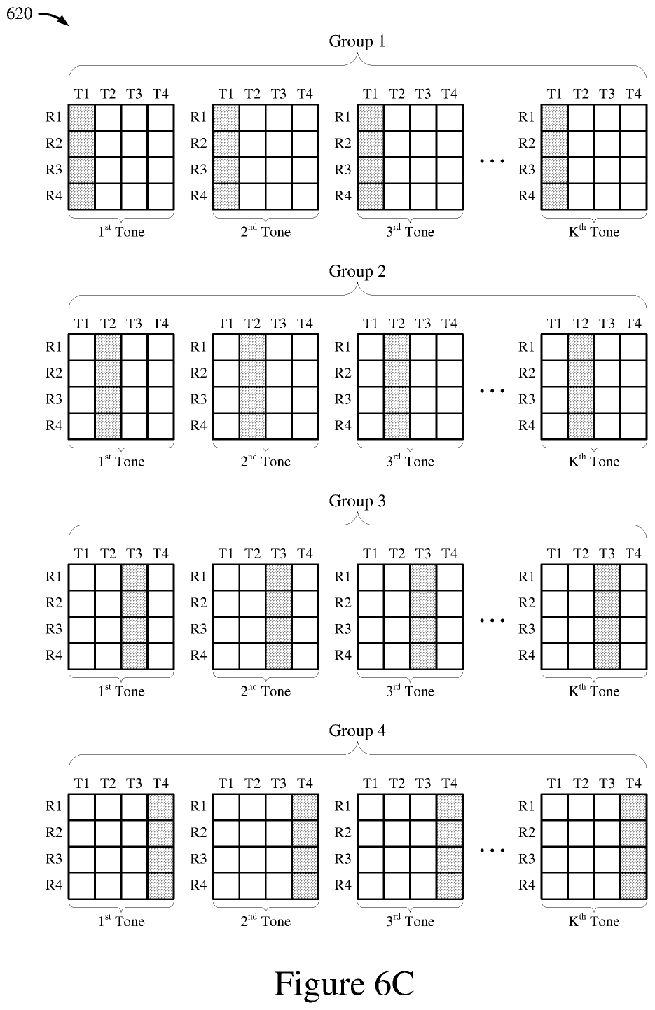

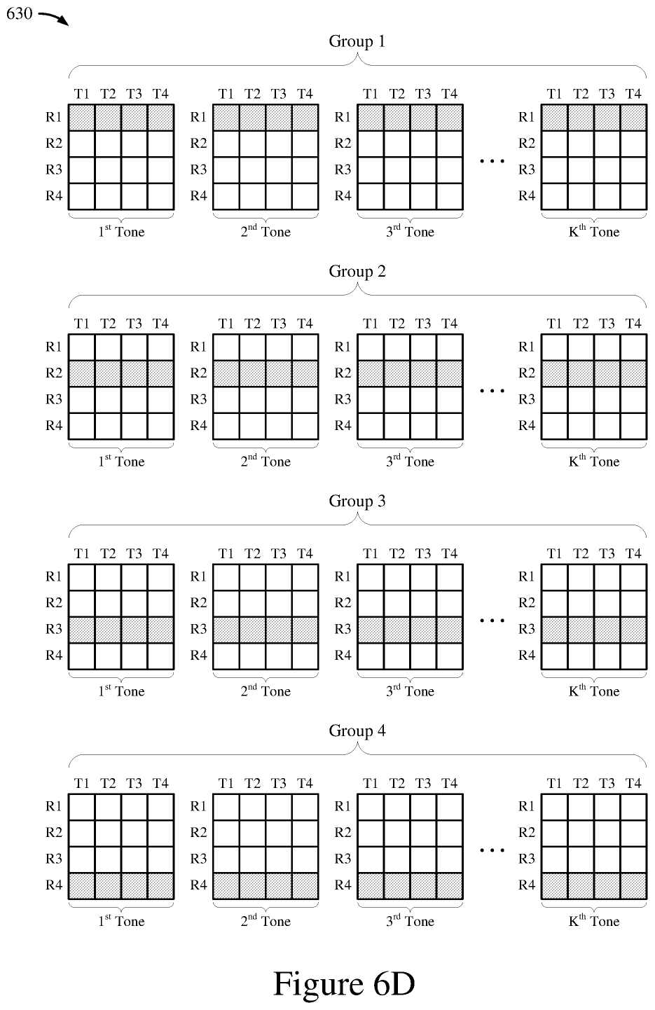

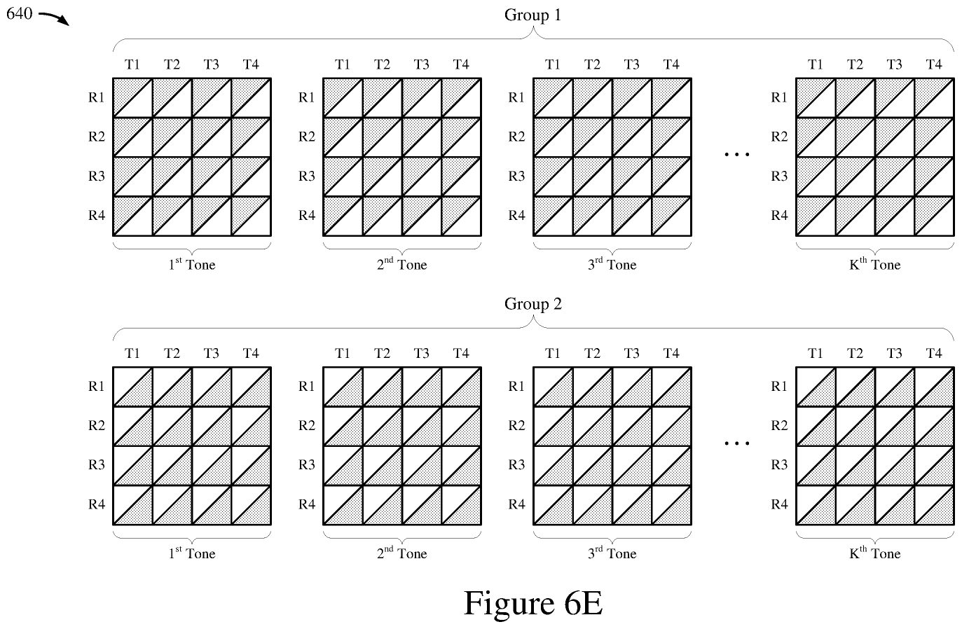

FIG. 6A shows an example CSI matrix 600 including a set of CFR values grouped into multiple subsets (Groups 1-4). In some implementations, the CSI matrix 600 may be one example of the CSI matrix 500 of FIG. 5. With reference for example to FIGS. 4A and 4B, the CSI matrix 600 may be captured or acquired by the RX device 420 responsive to receiving sounding packets, over a wireless channel spanning K tones, from the TX device 410. More specifically, the sounding packets may be transmitted using 4 TX antennas T1-T4 of the TX device 410 and received using 4 RX antennas R1-R4 of the RX device 420. Thus, each CFR value of the CSI matrix 600 indicates a respective channel frequency response associated with one of the TX antennas T1-T4, one of the RX antennas R1-R4, and one of the K tones, based on its location in the matrix. In some implementations, each of the CFR values may be assigned to one of Groups 1-4 based on its associated tone.

In the example of FIG. 6A, each of Groups 1-4 may include any CFR values, spanning the range of TX antennas T1-T4 and the range of RX antennas R1-R4, associated with a respective subset of tones. More specifically, each subset of tones is a decimated subset of the K tones having a respective offset or starting tone index (ranging from 1 to 4 in the example of FIG. 6A). For example, Group 1 includes all CFR values associated with the 1^{st} tone and every 4^{th} tone thereafter up to and including the K-3^{th} tone, Group 2 includes all CFR values associated with the 2^{nd} tone and every 4^{th} tone thereafter up to and including the K-2^{th} tone, Group 3 includes all CFR values associated with the 3^{rd} tone and every 4^{th} tone thereafter up to and including the K-1^{th} tone, and Group 4 includes all CFR values associated with the 4^{th} tone and every 4^{th} tone thereafter up to and including the Kth tone. More generally, each of subset of CFR values can be identified by a tuple (decimation factor, starting tone index). Accordingly, Groups 1-4 collectively represent a complete set of CFR values associated with the CSI matrix 600. In the example of FIG. 6A, each subset of tones has a decimation factor equal to 4. However, in some other implementations, any decimation factor may be used to decimate the K tones.

FIG. 6B shows an example CSI matrix 610 including a set of CFR values grouped into multiple subsets (Groups 1-4). In some implementations, the CSI matrix 610 may be one example of the CSI matrix 500 of FIG. 5. With reference for example to FIGS. 4A and 4B, the CSI matrix 610 may be captured or acquired by the RX device 420 responsive to receiving sounding packets, over a wireless channel spanning K tones, from the TX device 410. More specifically, the sounding packets may be transmitted using 4 TX antennas T1-T4 of the TX device 410 and received using 4 RX antennas R1-R4 of the RX device 420. Thus, each CFR value of the CSI matrix 610 indicates a respective channel frequency response associated with one of the TX antennas T1-T4, one of the RX antennas R1-R4, and one of the K tones, based on its location in the matrix. In some implementations, each of the CFR values may be assigned to one of Groups 1-4 based on its associated tone.

In the example of FIG. 6B, each of Groups 1-4 may include any CFR values, spanning the range of TX antennas T1-T4 and the range of RX antennas R1-R4, associated with a respective subset of tones. More specifically, each subset of tones spans a respective sub-band within the bandwidth of the wireless channel. For example, Group 1 includes all CFR values associated with the 1^{st} through x^{th} contiguous tones, Group 2 includes all CFR values associated with the x+1^{th} through y^{th} contiguous tones, Group 3 includes all CFR values associated with the y+1^{th} through z^{th} contiguous tones, and Group 4 includes all CFR values associated with the z+1^{th} through K^{th} contiguous tones. Each contiguous subset of tones may span a respective portion of the bandwidth spanned by tones 1-K. For example, assuming tones 1-K span an 80 MHz bandwidth, each contiguous subset of tones may span a respective 20 MHz portion of the 80 MHZ bandwidth. More generally, each subset of CFR values can be identified by a tuple (BW, BW index), where BW represents the bandwidth of the current operating channel and BW index indicates the position of a respective sub-band within the channel bandwidth. In some implementations, BW index may indicate a relative position associated with the current operating channel (such as the 1^{st}, 2^{nd}, 3^{rd}, or 4^{th} 20 MHZ subchannel of the current 80 MHz channel). In some other implementations, BW index may be a channel index as defined by existing versions of the IEEE 802.11 standard (such as a Channelization definition). Accordingly, Groups 1-4 collectively represent a complete set of CFR values associated with the CSI matrix 610. In the example of FIG. 6A, each subset of tones spans a quarter of the overall bandwidth. However, in some other implementations, each subset of tones may span any portion of the overall bandwidth.

FIG. 6C shows an example CSI matrix 620 including a set of CFR values grouped into multiple subsets (Groups 1-4). In some implementations, the CSI matrix 620 may be one example of the CSI matrix 500 of FIG. 5. With reference for example to FIGS. 4A and 4B, the CSI matrix 620 may be captured or acquired by the RX device 420 responsive to receiving sounding packets, over a wireless channel spanning K tones, from the TX device 410. More specifically, the sounding packets may be transmitted using 4 TX antennas T1-T4 of the TX device 410 and received using 4 RX antennas R1-R4 of the RX device 420. Thus, each CFR value of the CSI matrix 620) indicates a respective channel frequency response associated with one of the TX antennas T1-T4, one of the RX antennas R1-R4, and one of the K tones, based on its location in the matrix. In some implementations, each of the CFR values may be assigned to one of Groups 1-4 based on its associated TX antenna.

In the example of FIG. 6C, each of Groups 1-4 may include any CFR values, spanning the range of RX antennas R1-R4 and the range of tones K, associated with a respective subset of TX antennas. For example, Group 1 includes all CFR values associated with the 1^{st} TX antenna T1, Group 2 includes all CFR values associated with the 2^{nd} TX antenna T2, Group 3 includes all CFR values associated with the 3^{rd} TX antenna T3, and Group 4 includes all CFR values associated with the 4^{th} TX antenna T4. Accordingly, Groups 1-4 collectively represent a complete set of CFR values associated with the CSI matrix 620. In the example of FIG. 6C, each subset of TX antennas includes exactly 1 TX antenna. However, in some other implementations, any number of TX antennas may be included in a subset. For example, in some implementations, each subset of TX antennas may include 2 TX antennas. In such implementations, the number of subsets of CFR values may be halved compared to the number of subsets of CFR values depicted in FIG. 6C.

FIG. 6D shows an example CSI matrix 630 including a set of CFR values grouped into multiple subsets (Groups 1-4). In some implementations, the CSI matrix 630 may be one example of the CSI matrix 500 of FIG. 5. With reference for example to FIGS. 4A and 4B, the CSI matrix 630 may be captured or acquired by the RX device 420 responsive to receiving sounding packets, over a wireless channel spanning K tones, from the TX device 410. More specifically, the sounding packets may be transmitted using 4 TX antennas T1-T4 of the TX device 410 and received using 4 RX antennas R1-R4 of the RX device 420. Thus, each CFR value of the CSI matrix 630 indicates a respective channel frequency response associated with one of the TX antennas T1-T4, one of the RX antennas R1-R4, and one of the K tones, based on its location in the matrix. In some implementations, each of the CFR values may be assigned to one of Groups 1-4 based on its associated RX antenna.

In the example of FIG. 6D, each of Groups 1-4 may include any CFR values, spanning the range of TX antennas T1-T4 and the range of tones K, associated with a respective subset of RX antennas. For example, Group 1 includes all CFR values associated with the 1^{st} RX antenna R1, Group 2 includes all CFR values associated with the 2^{nd} RX antenna R2, Group 3 includes all CFR values associated with the 3^{rd} RX antenna R3, and Group 4 includes all CFR values associated with the 4^{th} RX antenna R4. Accordingly, Groups 1-4 collectively represent a complete set of CFR values associated with the CSI matrix 630. In the example of FIG. 6D, each subset of RX antennas includes exactly 1 RX antenna. However, in some other implementations, any number of RX antennas may be included in a subset. For example, in some implementations, each subset of RX antennas may include 2 RX antennas. In such implementations, the number of subsets of CFR values may be halved compared to the number of subsets of CFR values depicted in FIG. 6D.

FIG. 6E shows an example CSI matrix 640 including a set of CFR values grouped into multiple subsets (Groups 1 and 2). In some implementations, the CSI matrix 640 may be one example of the CSI matrix 500 of FIG. 5. With reference for example to FIGS. 4A and 4B, the CSI matrix 640 may be captured or acquired by the RX device 420 responsive to receiving sounding packets, over a wireless channel spanning K tones, from the TX device 410. More specifically, the sounding packets may be transmitted using 4 TX antennas T1-T4 of the TX device 410 and received using 4 RX antennas R1-R4 of the RX device 420. Thus, each CFR value of the CSI matrix 640 indicates a respective channel frequency response associated with one of the TX antennas T1-T4, one of the RX antennas R1-R4, and one of the K tones, based on its location in the matrix. In some implementations, portions of each CFR value may be assigned to one of Groups 1 or 2 so that different portions of the same CFR value are assigned to different groups.

In the example of FIG. 6E, each of Groups 1 and 2 may include a respective portion of each of the CFR values spanning the range of TX antennas T1-T4, the range of RX antennas R1-R4, and the range of tones K. For example, Group 1 includes a first portion of each CFR value of the CSI matrix 640 and Group 2 includes a second portion of each CFR value of the CSI matrix 640. In some implementations, the first portion may represent an in-phase (I) component of each CFR value and the second portion may represent a quadrature (Q) component of each CFR value. In some other implementations, the first portion may represent an amplitude component of each CFR value and the second portion may represent a phase component of each CFR value. Accordingly, Groups 1 and 2 collectively represent a complete set of CFR values associated with the CSI matrix 640. In the example of FIG. 6E, all the CFR values are grouped into two subsets. However, in some other implementations, the grouping may be more granular. For example, in some implementations, Group 1 may include the I or amplitude components for only a subset of the CFR values and Group 2 may include the Q or phase components for such subset of CFR values.

As described above, any of the subsets of CFR values depicted in FIGS. 6A-6E can be used to perform one or more RF sensing operations. Moreover, each of the subsets may be carried in the payload of a single management frame. Thus, in some implementations, an RX device may transmit a single CSI report, carrying one or more subsets of CFR values, in response to receiving a sounding packet from a TX device. In some other implementations, an RX device may transmit multiple CSI reports, each carrying one or more subsets of CFR values, so that a TX device receives a complete set of CFR values in response to a sounding packet. Still further, in some implementations, one or more of the grouping techniques described with reference to FIGS. 6A-6E can be combined to further reduce the size of each CSI report. For example, a given CSI report may include only the CFR values associated with every 4^{th} tone spanning a 20 MHz sub-band between a given RX antenna and a given TX antenna.

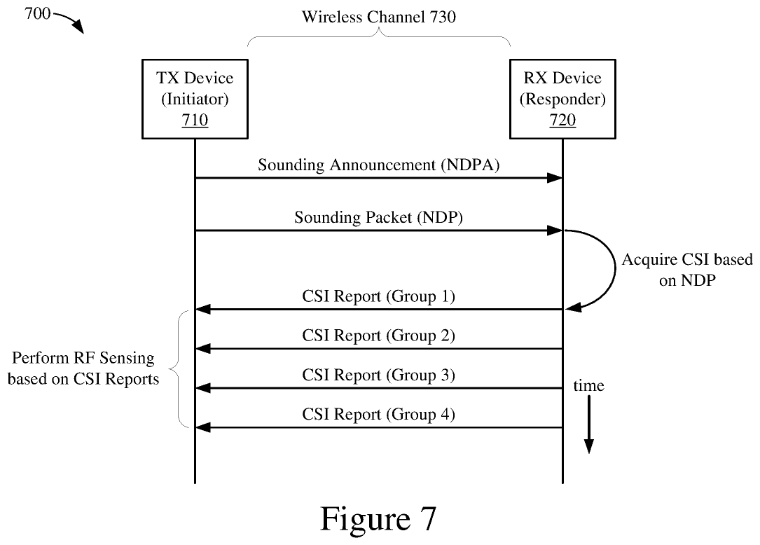

FIG. 7 shows a sequence diagram 700 depicting an example message exchange between devices participating in a channel sounding operation. In the example of FIG. 7, the channel sounding operation is performed between a TX device 710 (acting as the initiator) and an RX device 720 (acting as the responder). In some implementations, the TX device 710 may be one example of the AP 110 of FIG. 1 or the AP 300 of FIG. 3. In some other implementations, the TX device 710 may be one example of any of the STAs 120 of FIG. 1 or the STA 200 of FIG. 2. In some implementations, the RX device 720 may be one example of the AP 110 of FIG. 1 or the AP 300 of FIG. 3. In some other implementations, the RX device 720 may be one example of any of the STAs 120 of FIG. 1 or the STA 200 of FIG. 2.

The TX device 710 initiates the channel sounding operation by transmitting a sounding announcement, followed by a sounding packet, to the RX device 720. In some implementations, the sounding announcement may be an NDP announcement frame (NDPA) and the sounding packet may be an NDP. In some implementations, the NDPA may indicate one or more subsets of CFR values to be reported by the RX device 720 (in one or more CSI reports). In some other implementations, the NDPA may indicate how the CFR values are to be grouped across multiple CSI reports. The sounding packet includes a known pattern or sequence of training signals (transmitted in one or more LTFs) that can be used to acquire CSI. The TX device 710 may transmit the sounding packet, via a number (M) of TX antennas, on a number (K) of tones spanning a bandwidth of a wireless channel 730 between the TX device 710 and the RX device 720. The RX device 720 receives the sounding packet via a number (N) of RX antennas and acquires CSI based on the received training signals (such as described with reference to FIGS. 4A and 4B). The CSI can be modeled as an M×N×K matrix of CFR values (such as the CSI matrix 500 of FIG. 5), where each of the CFR values indicates a channel frequency response associated with a respective one of the M TX antennas, a respective one of the N RX antennas, and a respective one of the K tones.

In some aspects, the RX device 720 may group the CFR values into multiple subsets (Groups 1-4), where each subset of CFR values is usable for one or more RF sensing operations and is small enough to be transmitted in a single management. In some implementations, the CFR values may be grouped according to the K tones so that CFR values associated with the same subset of tones are grouped into the same subset of CFR values (such as described with reference to FIGS. 6A and 6B). In some other implementations, the CFR values may be grouped according to the M TX antennas so that CFR values associated with the same subset of TX antennas are grouped into the same subset of CFR values (such as described with reference to FIG. 6C). In some implementations, the CFR values may be grouped according to the N RX antennas so that CFR values associated with the same subset of RX antennas are grouped into the same subset of CFR values (such as described with reference to FIG. 6D). Still further, in some implementations, at least one subset may include only the in-phase or amplitude components of one or more CFR values and another subset may include only the quadrature or phase components of the one or more CFR values (such as described with reference to FIG. 6E).

The RX device 720 further transmits one or more CSI report frames back to the TX device 710. In some implementations, each CSI report may include a respective subset of the CFR values. As shown in FIG. 7, the RX device 720 transmits a CSI report carrying the CFR values in Group 1, followed by a CSI report carrying the CFR values in Group 2, followed by a CSI report carrying the CFR values in Group 3, followed by a CSI report carrying the CFR values in Group 4. The TX device 710 may perform one or more RF sensing operations upon receiving any of the CSI reports. For example, the TX device 710 may perform at least part of an RF sensing operation, based on the CFR values in Group 1, upon receiving the first CSI report from the RX device 720. In some implementations, each CSI report may be transmitted in response to a respective trigger frame (not shown for simplicity) received from the TX device 710. In some other implementations, the CSI reports may be transmitted in response to a single trigger frame (not shown for simplicity) received from the TX device 710. For example, each CSI report may be transmitted as a respective medium access control (MAC) protocol data unit (MPDU) of an aggregated MPDU (A-MPDU). The TX device 710 may subsequently update the RF sensing operation, or may perform a new RF sensing operation, responsive to each subsequent CSI report.

In the example of FIG. 7, the RX device 720 transmits 4 CSI reports carrying the CFR values associated with Groups 1-4. In some implementations, Groups 1-4 may collectively represent a complete set of CFR values associated with the wireless channel 730. In some other implementations, Groups 1-4 may include only a partial set of the CFR values associated with the wireless channel 730. Still further, in some implementations, the RX device 720 may transmit fewer or more CSI reports than what is depicted in FIG. 7. In some implementations, the TX device 710 and the RX device 720 may negotiate the number of CSI reports to be transmitted by the RX device 720 prior to initiating the channel sounding operation. In such implementations, the TX device 710 and the RX device 720 also may negotiate the subset of CFR values to be included in each of the CSI reports.

In some other implementations, the RX device 720 may determine the number of CSI reports to be transmitted to the TX device 710 and the subset of CFR values to be included in each CSI report. In such implementations, the RX device 720) may provide grouping information in each of the CSI reports identifying the subset of CFR values provided therein. With reference for example to FIG. 6A, the grouping information may indicate the decimation factor and the respective offset associated with each reported subset of tones. With reference for example to FIG. 6B, the grouping information may indicate the respective sub-band associated with each reported subset of tones. With reference for example to FIG. 6C, the grouping information may indicate the respective TX antennas associated with each reported subset of TX antennas. With reference for example to FIG. 6D, the grouping information may indicate the respective RX antennas associated with each reported subset of RX antennas. With reference for example to FIG. 6E, the grouping information may indicate which component of each CFR value is included in each reported subset.

In some other implementations, the TX device 710 may determine the number of CSI reports to be transmitted by the RX device 720 and the subset of CFR values to be included in each CSI report. In such implementations, the TX device 710 may provide a CSI request in the trigger frame or the NDPA indicating the subset of CFR values to be included in each CSI report. With reference for example to FIG. 6A, the CSI request may indicate the decimation factor and the respective offset associated with each requested subset of tones. With reference for example to FIG. 6B, the CSI request may indicate the respective sub-band associated with each requested subset of tones. With reference for example to FIG. 6C, the CSI request may indicate the respective TX antennas associated with each requested subset of TX antennas. With reference for example to FIG. 6D, the CSI request may indicate the respective RX antennas associated with each requested subset of RX antennas. With reference for example to FIG. 6E, the CSI request may indicate which component of each CFR value is to be included in each requested subset.

In the example of FIG. 7, the RX device 720 transmits each of the CSI reports in response to the same sounding packet transmitted by the TX device 710. In other words, the CFR values in each of Groups 1-4 are derived from the same CSI capture. Aspects of the present disclosure recognize that a wireless channel may experience little (if any) change over a short duration of time. Thus, when multiple sounding packets are transmitted within such short duration, the CSI acquired from each of the sounding packets may be substantially similar. Thus, in some implementations, an RX device may acquire different subsets of CFR values responsive to different sounding packets transmitted by a TX device, where each subset of CFR values can be treated as if derived from the same CSI capture.

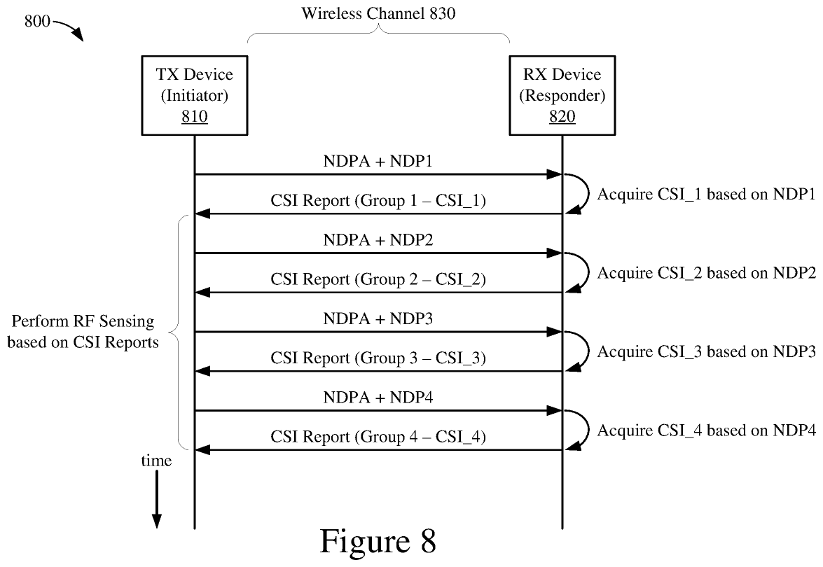

FIG. 8 shows a sequence diagram 800 depicting an example message exchange between devices participating in a channel sounding operation. In the example of FIG. 8, the channel sounding operation is performed between a TX device 810 (acting as the initiator) and an RX device 820 (acting as the responder). In some implementations, the TX device 810 may be one example of the AP 110 of FIG. 1 or the AP 300 of FIG. 3. In some other implementations, the TX device 810 may be one example of any of the STAs 120 of FIG. 1 or the STA 200 of FIG. 2. In some implementations, the RX device 820 may be one example of the AP 110 of FIG. 1 or the AP 300 of FIG. 3. In some other implementations, the RX device 820 may be one example of any of the STAs 120 of FIG. 1 or the STA 200 of FIG. 2.

The TX device 810 initiates the channel sounding operation by transmitting a sounding announcement (NDPA), followed by a first sounding packet (NDP1), to the RX device 820. In the example of FIG. 8, the TX device 810 transmits a series of NDPAs and NDPs within a short period of time. More specifically, the TX device 810 transmits three additional sounding announcements, each followed by a respective sounding packet (NDP2-NDP4), shortly after transmitting the first sounding packet NDP1. In some implementations, TX device 810 may transmit each of the sounding packets NDP1-NDP4, via a number (M) of TX antennas, on a number (K) of tones spanning a bandwidth of a wireless channel 830 between the TX device 810 and the RX device 820. The RX device 820 receives each of the sounding packets NDP1-NDP4 via a number (N) of RX antennas and acquires CSI (CSI_1-CSI_4) based on the received training signals in the sounding packets NDP1-NDP4, respectively (such as described with reference to FIGS. 4A and 4B). Thus, each CSI can be modeled as a respective M×N×K matrix of CFR values (such as the CSI matrix 500 of FIG. 5).

For each CSI, the RX device 820 may group the CFR values associated therewith into multiple subsets (Groups 1-4), where each subset of CFR values is usable for one or more RF sensing operations and is small enough to be transmitted in a single management. In some implementations, the CFR values may be grouped according to the K tones so that CFR values associated with the same subset of tones are grouped into the same subset of CFR values (such as described with reference to FIGS. 6A and (B). In some other implementations, the CFR values may be grouped according to the M TX antennas so that CFR values associated with the same subset of TX antennas are grouped into the same subset of CFR values (such as described with reference to FIG. 6C). In some implementations, the CFR values may be grouped according to the N RX antennas so that CFR values associated with the same subset of RX antennas are grouped into the same subset of CFR values (such as described with reference to FIG. 6D). Still further, in some implementations, at least one subset may include only the in-phase or amplitude components of one or more CFR values and another subset may include only the quadrature or phase components of the one or more CFR values (such as described with reference to FIG. 6E).

The RX device 820 transmits a respective CSI report frame back to the TX device 810 for each of the sounding packets NDP1-NDP4. In some implementations, each CSI report may include a respective subset of CFR values from a respective CSI. As shown in FIG. 8, the RX device 820 transmits a CSI report carrying the CFR values in Group 1 of CSI_1, followed by a CSI report carrying the CFR values in Group 2 of CSI_2, followed by a CSI report carrying the CFR values in Group 3 of CSI_3, followed by a CSI report carrying the CFR values in Group 4 of CSI_4. In some implementations, each CSI report may be transmitted in response to a respective trigger frame (not shown for simplicity) received form the TX device 810. In some other implementations, the CSI reports may be transmitted in response to a single trigger frame (not shown for simplicity) received from the TX device 810. For example, each CSI report may be transmitted as a respective MPDU of an A-MPDU. The TX device 810 may perform one or more RF sensing operations upon receiving any of the CSI reports. For example, the TX device 810 may perform at least part of an RF sensing operation, based on the CFR values in Group 1, upon receiving the first CSI report from the RX device 820. The TX device 810 may subsequently update the RF sensing operation, or may perform a new RF sensing operation, responsive to each subsequent CSI report.

In the example of FIG. 8, the RX device 820 transmits 4 CSI reports carrying the CFR values associated with Groups 1-4 of CSI_1-CSI_4, respectively. In some implementations, Groups 1-4 may collectively represent a complete set of CFR values associated with the wireless channel 830. In some other implementations, Groups 1-4 may include only a partial set of the CFR values associated with the wireless channel 830. Still further, in some implementations, the RX device 820 may transmit fewer or more CSI reports than what is depicted in FIG. 8. In some implementations, the TX device 810 and the RX device 820 may negotiate the number of CSI reports to be transmitted by the RX device 820 prior to initiating the channel sounding operation. In such implementations, the TX device 810 and the RX device 820) also may negotiate the subset of CFR values to be included in each of the CSI reports.

In some other implementations, the RX device 820 may determine the number of CSI reports to be transmitted to the TX device 810 and the subset of CFR values to be included in each CSI report. In such implementations, the RX device 820) may provide grouping information in each of the CSI reports identifying the subset of CFR values provided therein (such as described with reference to FIG. 7). In some other implementations, the TX device 810 may determine the number of CSI reports to be transmitted by the RX device 820) and the subset of CFR values to be included in each CSI report. In such implementations, the TX device 810 may provide a CSI request in the trigger frame or in each NDPA indicating the subset of CFR values to be included in each CSI report (such as described with reference to FIG. 7).

In the examples of FIGS. 7 and 8, each CSI report is carried in a respective management frame (such as an action frame). Aspects of the present disclosure recognize that, by reducing the size of each CSI report, multiple CSI reports can be carried in the same management frame. In some aspects, each CSI report may include CSI for a different wireless channel. In some implementations, an RX device may acquire each CSI in response to a respective sounding packet transmitted by the same TX device. In some other implementations, an RX device may acquire each CSI in response to a sounding packet transmitted by a respective TX device. By including multiple CSI reports in a single management frame, aspects of the present disclosure may reduce the overhead associated with reporting CSI. For example, a TX device or initiator can perform multiple RF sensing operations (in different wireless channels) responsive to a single CSI report.

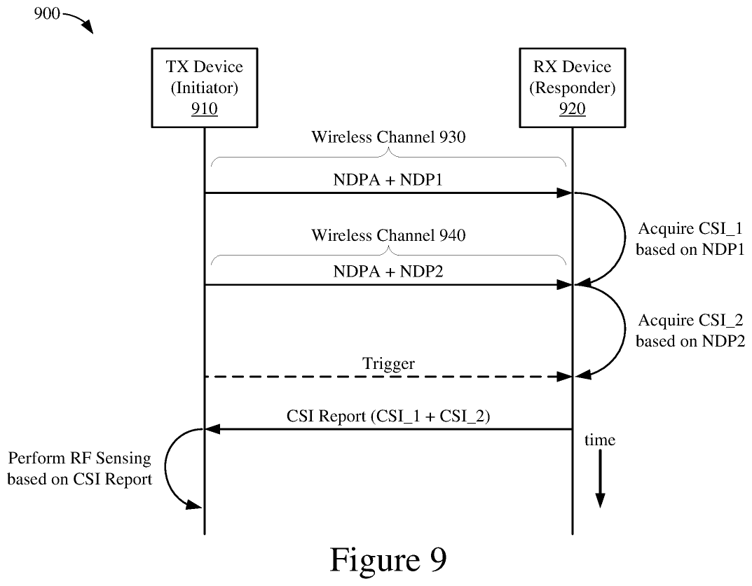

FIG. 9 shows a sequence diagram 900 depicting an example message exchange between devices participating in a channel sounding operation. In the example of FIG. 9, the channel sounding operation is performed between a TX device 910 (acting as the initiator) and an RX device 920 (acting as the responder). In some implementations, the TX device 910 may be one example of the AP 110 of FIG. 1 or the AP 300 of FIG. 3. In some other implementations, the TX device 910 may be one example of any of the STAs 120 of FIG. 1 or the STA 200 of FIG. 2. In some implementations, the RX device 920 may be one example of the AP 110 of FIG. 1 or the AP 300 of FIG. 3. In some other implementations, the RX device 920 may be one example of any of the STAs 120 of FIG. 1 or the STA 200 of FIG. 2.

The TX device 910 initiates the channel sounding operation by transmitting a sounding announcement (NDPA), followed by a first sounding packet (NDP1), to the RX device 920. For example, the TX device 910 may transmit NDP1, via a number (M) of TX antennas, on a number (K) of tones spanning a bandwidth of a first wireless channel 930 between the TX device 910 and the RX device 920. The RX device 920 receives NDP1 via a number (N) of RX antennas and acquires first CSI (CSI_1) based on the received training signals in NDP1 (such as described with reference to FIGS. 4A and 4B). The first CSI can be modeled as an M×N×K matrix of CFR values (such as the CSI matrix 500 of FIG. 5), where each of the CFR values indicates a channel frequency response associated with a respective one of the M TX antennas, a respective one of the N RX antennas, and a respective one of the K tones.

In the example of FIG. 9, the TX device 910 subsequently transmits another sounding announcement, followed by a second sounding packet (NDP2), to the RX device 920. For example, the TX device 910 may transmit NDP2, via a number (X) of TX antennas, on a number (Z) of tones spanning a bandwidth of a second wireless channel 940 between the TX device 910 and the RX device 920. The RX device 920 receives NDP2 via a number (Y) of RX antennas and acquires second CSI (CSI_2) based on the received training signals in NDP2 (such as described with reference to FIGS. 4A and 4B). The second CSI can be modeled as an X×Y×Z matrix of CFR values (such as the CSI matrix 500 of FIG. 5), where each of the CFR values indicates a channel frequency response associated with a respective one of the X TX antennas, a respective one of the Y RX antennas, and a respective one of the Z tones. In some aspects, at least one of M, N, or K may be different than X, Y, or Z, respectively. Thus, CSI_1 may be different than CSI_2.

In some implementations, the TX device 910 may transmit a trigger frame to the RX device 920 soliciting feedback associated with the wireless channels 930) and 940. The RX device 920 may respond to the trigger frame (or NDP1 and NDP2) by transmitting a CSI report frame back to the TX device 910. In some aspects, the CSI report frame may carry feedback associated with CSI_1 and CSI_2. In some implementations, the feedback may include a complete set of CFR values for each of CSI_1 and CSI_2. For example, the feedback may include raw or uncompressed CFR values. Alternatively, the size of the feedback may be reduced through compression, quantization, or decimation (such as described with reference to FIG. 6A). In some other implementations, the feedback may include only a subset of CFR values for at least one of CSI_1 or CSI_2 (such as described with reference to FIGS. 7 and 8). Accordingly, the TX device 910 may perform one or more RF sensing operations in each of the wireless channels 930 and 940 based on the feedback associated with CSI_1 and CSI_2, respectively.

In the example of FIG. 9, the RX device 920 transmits a single CSI report frame carrying feedback or CSI associated with two wireless channels 930 and 940. In some implementations, a CSI report frame may carry feedback or CSI for more than two wireless channels. In some other implementations, an RX device may transmit multiple CSI report frames carrying feedback or CSI for two or more wireless channels, where each CSI report frame carries a portion of the feedback or CSI for each of the two or more wireless channels. In some aspects, the TX device 910 and the RX device 920) may negotiate the number of CSI reports to be transmitted by the RX device 920 prior to initiating the channel sounding operation. Accordingly, the TX device 910 and the RX device 920 also may negotiate the number of wireless channels represented in each CSI report frame and the size of the feedback or CSI associated with each wireless channel.

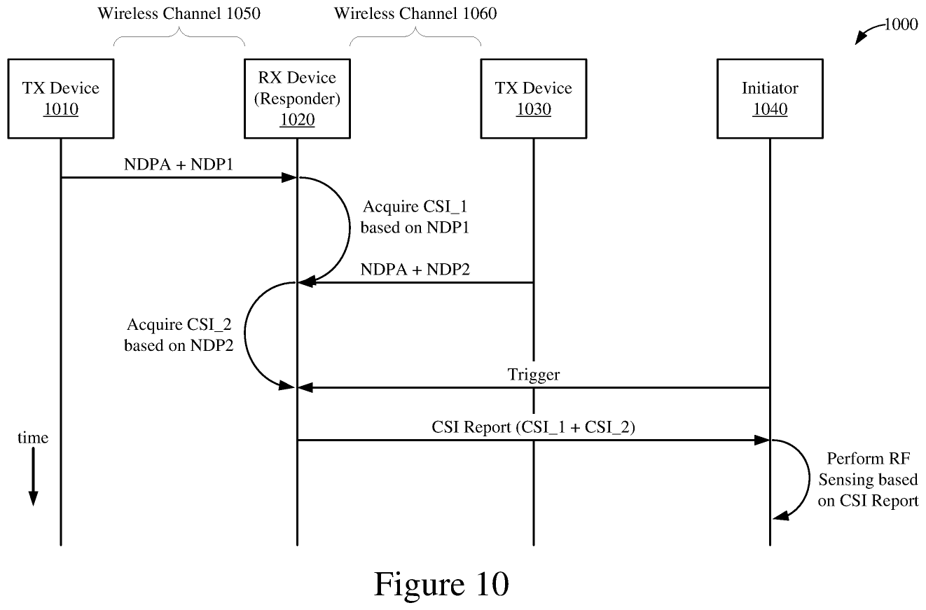

FIG. 10 shows a sequence diagram depicting 1000 an example message exchange between devices participating in a channel sounding operation. In the example of FIG. 10, the channel sounding operation is performed between an initiator device 1040, multiple TX devices 1010 and 1030, and an RX device 1020 (acting as the responder). In some implementations, at least one of the TX devices 1010 or 1030 may be one example of the AP 110 of FIG. 1 or the AP 300 of FIG. 3. In some other implementations, at least one of the TX devices 1010 or 1030 may be one example of any of the STAs 120 of FIG. 1 or the STA 200 of FIG. 2. In some implementations, the RX device 1020 may be one example of the AP 110 of FIG. 1 or the AP 300 of FIG. 3. In some other implementations, the RX device 1020 may be one example of any of the STAs 120 of FIG. 1 or the STA 200 of FIG. 2.

The first TX device 1010 initiates the channel sounding operation (on behalf of the initiator 1040) by transmitting a sounding announcement (NDPA), followed by a first sounding packet (NDP1), to the RX device 1020. For example, the first TX device 1010 may transmit NDP1, via a number (M) of TX antennas, on a number (K) of tones spanning a bandwidth of a first wireless channel 1050 between the first TX device 1010 and the RX device 1020. The RX device 1020 receives NDP1 via a number (N) of RX antennas and acquires first CSI (CSI_1) based on the received training signals in NDP1 (such as described with reference to FIGS. 4A and 4B). The first CSI can be modeled as an M×N×K matrix of CFR values (such as the CSI matrix 500 of FIG. 5), where each of the CFR values indicates a channel frequency response associated with a respective one of the M TX antennas, a respective one of the N RX antennas, and a respective one of the K tones.

In the example of FIG. 10, the second TX device 1030 subsequently transmits a sounding announcement, followed by a second sounding packet (NDP2), to the RX device 1020. For example, the second TX device 1030 may transmit NDP2, via a number (X) of TX antennas, on a number (Z) of tones spanning a bandwidth of a second wireless channel 1060 between the second TX device 1030 and the RX device 1020. The RX device 1020 receives NDP2 via a number (Y) of RX antennas and acquires second CSI (CSI_2) based on the received training signals in the second sounding packet (such as described with reference to FIGS. 4A and 4B). The second CSI can be modeled as an X×Y×Z matrix of CFR values (such as the CSI matrix 500 of FIG. 5), where each of the CFR values indicates a channel frequency response associated with a respective one of the X TX antennas, a respective one of the Y RX antennas, and a respective one of the Z tones. In some aspects, at least one of M, N, or K may be different than X, Y, or Z, respectively. Thus, CSI_1 may be different than CSI_2.

In some implementations, the initiator 1040 may transmit a trigger frame to the RX device 1020 soliciting feedback associated with the wireless channels 1050 and 1060. The RX device 1020 may respond to the trigger frame by transmitting a CSI report frame back to the initiator 1040. In some aspects, the CSI report frame may carry feedback associated with CSI_1 and CSI_2. In some implementations, the feedback may include a complete set of CFR values for each of CSI_1 and CSI_2. For example, the feedback may include raw or uncompressed CFR values. Alternatively, the size of the feedback may be reduced through compression, quantization, or decimation (such as described with reference to FIG. 6A). In some other implementations, the feedback may include only a subset of CFR values for at least one of CSI_1 or CSI_2 (such as described with reference to FIGS. 7 and 8). Accordingly, the initiator 1040 may perform one or more RF sensing operations in each of the wireless channels 1050 and 1060 based on the feedback associated with CSI_1 and CSI_2, respectively.

In the example of FIG. 10, the RX device 1020 transmits a single CSI report frame carrying feedback or CSI associated with two wireless channels 1050 and 1060. In some implementations, a CSI report frame may carry feedback or CSI for more than two wireless channels. In some other implementations, an RX device may transmit multiple CSI report frames carrying feedback or CSI for two or more wireless channels, where each CSI report frame carries a portion of the feedback or CSI for each of the two or more wireless channels. In some aspects, the initiator 1040 and the RX device 1020 may negotiate the number of CSI reports to be transmitted by the RX device 1020 prior to initiating the channel sounding operation. Accordingly, the initiator 1040 and the RX device 1020 also may negotiate the number of wireless channels represented in each CSI report frame and the size of the feedback associated with each wireless channel.

Each CSI report frame may include one or more report fields configured to carry the feedback or CSI (including any subset of CFR values) for a respective wireless channel. In some aspects, each CSI report frame also may include one or more control fields configured to carry metadata associated with the feedback or CSI carried in the one or more report fields, respectively. Aspects of the present disclosure recognize that the captured CSI depends on the transmission parameters of the TX device, the reception parameters of the RX device, and the characteristics of the environment. In other words, changing any of the transmission or reception parameters between channel sounding events may cause changes in CSI that are not attributable to changes in the environment. In some aspects, the metadata may indicate one or more properties or characteristics of the TX device, the RX device, or the transmission or reception of the sounding packets associated with each CSI capture. Examples of metadata that can be included in a control field of a CSI report frame are summarized. below. in Table 1.

TABLE 1

| Type | Description |
|---|---|
| Vendor ID | Identifies the vendor associated with the TX device |
| | or initiator, or indicates the format of the CFR |
| MAC Address | Indicates the MAC address of the RX device or |
| | responder |
| Capture Status | Indicates whether CSI was successfully capture or |
| | acquired |
| Capture | Indicates the bandwidth of the wireless channel or the |
| Bandwidth | received sounding packet |
| Channel | Indicates a primary 20 MHz subchannel of the wireless |
| | channel |
| Band center freq1 | Indicates a first center frequency of the bandwidth |
| Band center freq2 | Indicates a second center frequency of the bandwidth |
| cfreq/seg0/seg1 | Identifies the subset of CFR values included in the |
| | report |
| Preamble Type | Indicates the version of the PHY preamble used for the |
| | sounding packet (such as legacy, high throughput |
| | (HT), very high throughput (VHT), high efficiency |
| | (HE), or extremely high throughput (EHT), among |
| | other examples) |
| NSS | Indicates the number of spatial streams or TX |
| | antennas used to transmit the sounding packet |
| Per-Chain RSSI | Indicates the received signal strength indication |
| | (RSSI) per RX antenna chain |
| CFO | Indicates the carrier frequency offset (CFO) at the |
| | RX device |
| AGC Gain | Indicates the gain applied via automatic gain control |
| | (AGC), as measured by hardware, at the RX device |
| RX Chain Mask | Indicates the RX antennas associated with the CSI |
| | capture |
| Timestamp | Indicates the arrival time of the sounding packet |
| Length | Indicates the size or length of the corresponding |
| | report field |
| Per-Chain | Indicates changes to the phases of received signals, |
| Phase | per RX antenna chain, attributable to the hardware |
| | of the RX device |
| Decimation | Indicates the decimation factor associated with the |
| | CSI capture |
| RX Rate Info | Indicates the coding rate or modulation and coding |
| | scheme (MCS) used to transmit the sounding packet |
| MU Information | Indicates whether the sounding packet conforms to a |
| | single-user (SU) or multi-user (MU) packet format |
| Number of | Indicates the number of bits used to quantize each |
| Bits | CFR value |

Aspects of the present disclosure recognize that new signaling techniques may be needed to support the aggregation of multiple CSI reports in a single management frame. More specifically, such signaling may be necessary to delineate or distinguish the feedback or CSI associated with a given wireless channel from the feedback or CSI associated with another wireless channel in the same CSI report frame. In some implementations, each pair of control and header fields associated with a given wireless channel may be carried in a respective information element (IE) of a management frame, where the IE further includes a length field indicating a length of the IE. In some other implementations, the control and header fields may be sequentially positioned in the frame body of a management frame, where each control field immediately precedes a corresponding report field and carries length information indicating a length of that report field. Still further, in some implementations, one or more delimiters may be added to the frame body of a management frame to delineate control and report fields associated with different wireless channels. In some aspects, multiple CSI reports may be aggregated for transmission in a single packet or physical layer convergence protocol (PLCP) protocol data unit (PPDU). For example, each CSI report may be transmitted as a respective MPDU of an A-MPDU.

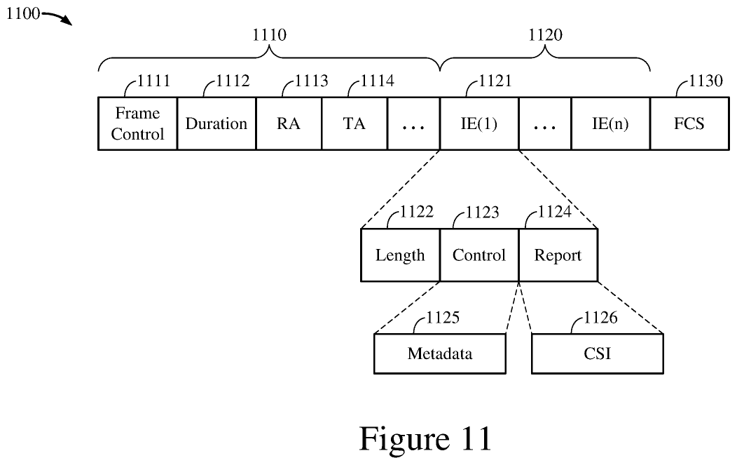

FIG. 11 shows an example CSI report frame 1100 for multiple captures. In some implementations, the CSI report frame 1100 may be one example of any of the CSI report frames of FIGS. 7-10. More specifically, the CSI report frame 1100 may be a management frame that is configured to carry feedback or CSI associated with one or more wireless channels.

The CSI report frame 1100 includes a MAC header 1110, a frame body 1120, and a frame check sequence (FCS) 1130. The MAC header 1110 includes a frame control field 1111, a duration field 1112, a receiver address (RA) field 1113, and a transmitter address (TA) field 1114. The frame body 1120 includes a number (n) of IEs 1121 each having a respective length field 1122 indicating a length of the IE 1121. In some implementations, the feedback or CSI associated with each wireless channel may be carried in a respective IE 1121. For example, as shown in FIG. 11, an IE 1121 may further include a control field 1123 and a report field 1124. The report field 1124 carries CSI 1126 (or feedback) associated with a respective wireless channel. In some implementations, the CSI 1126 may include a complete set of CFR values captured for the wireless channel. In some other implementations, the CSI 1126 may include only a subset of the CFR values captured for the wireless channel. The control field 1123 carries metadata 1125 associated with the CSI 1126. The metadata 1125 may indicate one or more properties or characteristics of the TX device, the RX device, or the transmission or reception of the sounding packets associated with the CSI 1126. For example, the metadata 1125 may include any of the information listed in Table 1.

In some implementations, multiple IEs 1121 may be used to carry feedback or CSI associated with multiple wireless channels, respectively. As such, a recipient of the CSI report frame 1100 (such as a TX device or initiator) may distinguish the CSI associated with each wireless channel based on the length field 1122 of each IE 1121. For example, the TX device or initiator may detect the control field 1123 and the report field 1124 based on the length field 1122 and may determine that the metadata 1125 in the control field 1123 and the CSI 1126 in the report field 1124 are associated with a particular wireless channel.

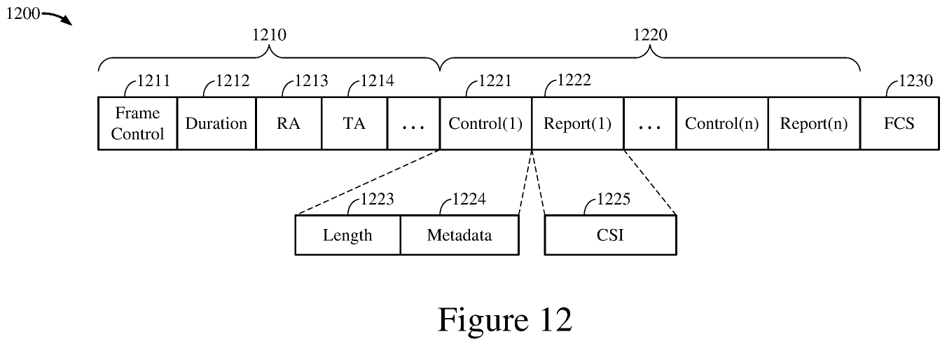

FIG. 12 shows an example CSI report frame 1200 for multiple captures. In some implementations, the CSI report frame 1200 may be one example of any of the CSI report frames of FIGS. 7-10. More specifically, the CSI report frame 1200 may be a management frame that is configured to carry feedback or CSI associated with one or more wireless channels.

The CSI report frame 1200 includes a MAC header 1210, a frame body 1220), and an FCS 1230. The MAC header 1210 includes a frame control field 1211, a duration field 1212, an RA field 1213, and a TA field 1214. The frame body 1220) includes a number (n) of control fields 1221 and report fields 1222. Each report field 1222 carries CSI 1225 (or feedback) associated with a respective wireless channel. In some implementations, the CSI 1225 may include a complete set of CFR values captured for the wireless channel. In some other implementations, the CSI 1225 may include only a subset of the CFR values captured for the wireless channel. Each control field 1221 immediately preceding a report field 1222 carries metadata 1224 associated with the CSI 1225 in the report field 1222. The metadata 1224 may indicate one or more properties or characteristics of the TX device, the RX device, or the transmission or reception of the sounding packets associated with the CSI 1225. For example, the metadata 1224 may include any of the information listed in Table 1.

Unlike the CSI report frame 1100 of FIG. 11, the control fields 1221 and report fields 1222 are not bounded by IEs. Thus, in some aspects, each control field 1221 may further carry length information 1223 indicating the length of the following report field 1222. In some implementations, multiple control fields 1221 and multiple report fields 1222 may be arranged, sequentially, in the frame body 1220. As such, a recipient of the CSI report frame 1200 (such as a TX device or initiator) may distinguish the CSI associated with each wireless channel based on the length information 1223 in each control field 1221. For example, the TX device or initiator may detect the report field 1222 based on the length information 1223 and may determine that the metadata 1224 in the control field 1221 and the CSI 1225 in the report field 1222 are associated with a particular wireless channel.

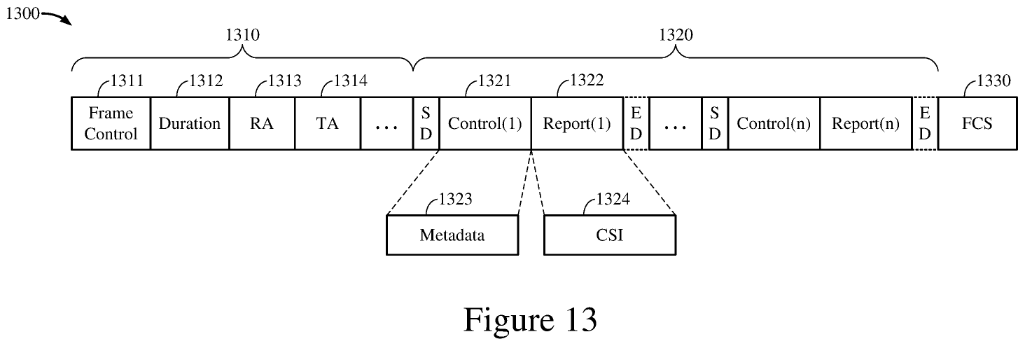

FIG. 13 shows an example CSI report frame 1300 for multiple captures. In some implementations, the CSI report frame 1300 may be one example of any of the CSI report frames of FIGS. 7-10. More specifically, the CSI report frame 1300 may be a management frame that is configured to carry feedback or CSI associated with one or more wireless channels.

The CSI report frame 1300 includes a MAC header 1310, a frame body 1320, and an FCS 1330. The MAC header 1310) includes a frame control field 1311, a duration field 1312, an RA field 1313, and a TA field 1314. The frame body 1320) includes a number (n) of control fields 1321 and report fields 1322. Each report field 1322 carries CSI 1324 (or feedback) associated with a respective wireless channel. In some implementations, the CSI 1324 may include a complete set of CFR values captured for the wireless channel. In some other implementations, the CSI 1324 may include only a subset of the CFR values captured for the wireless channel. Each control field 1321 immediately preceding a report field 1322 carries metadata 1323 associated with the CSI 1324 in the report field 1322. The metadata 1323 may indicate one or more properties or characteristics of the TX device, the RX device, or the transmission or reception of the sounding packets associated with the CSI 1324. For example, the metadata 1323 may include any of the information listed in Table 1.

Unlike the CSI report frame 1100 of FIG. 11, the control fields 1221 and report fields 1222 are not bounded by IEs. Thus, in some aspects, one or more delimiters may be inserted between the control fields 1221 and report fields 1222 associated with different wireless channels. For example, each delimiter may include a known sequence of bits. In some implementations, a start delimiter (SD) may be inserted immediately before each control field 1321. In some other implementations, an end delimiter (ED) may immediately be inserted immediately after each report field 1322. In some implementations, multiple control fields 1321 and multiple report fields 1322 may be included in the frame body 1320. As such, a recipient of the CSI report frame 1300 (such as a TX device or initiator) may distinguish the CSI associated with each wireless channel based on the delimiters (SD or ED). For example, the TX device or initiator may detect a control field 1321 and a report field 1322 based on the location of a delimiter and may determine that the metadata 1323 in the control field 1321 and the CSI 3124 in the report field 1322 are associated with a particular wireless channel.

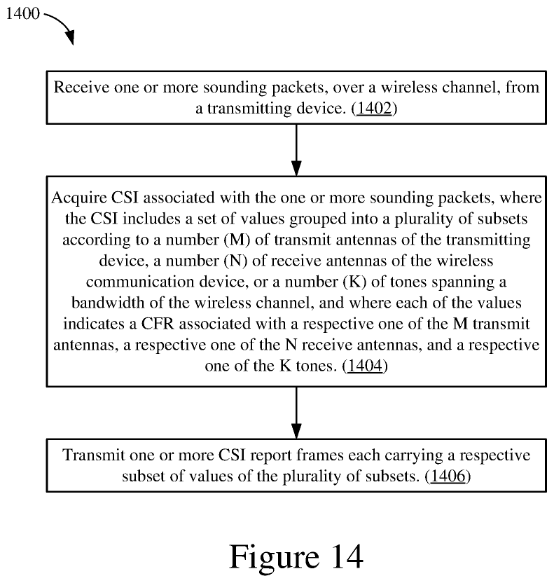

FIG. 14 shows an illustrative flowchart depicting an example wireless communication operation 1400. The example operation 1400 may be performed by a wireless communication device such as any of the RX devices 720, 820, 920, or 1020 of FIGS. 7-10, respectively.

The wireless communication device receives one or more sounding packets, over a wireless channel, from a transmitting device (1402). The wireless communication device further acquires CSI associated with the one or more sounding packets, where the CSI includes a set of values grouped into a plurality of subsets according to a number (M) of transmit antennas of the transmitting device, a number (N) of receive antennas of the wireless communication device, or a number (K) of tones spanning a bandwidth of the wireless channel, and where each of the values indicates a CFR associated with a respective one of the M transmit antennas, a respective one of the N receive antennas, and a respective one of the K tones (1404).

In some implementations, each of the plurality of values may be associated with the same sounding packet of the one or more sounding packets. In some other implementations, the wireless communication device may acquire one or more first values of the plurality of values associated with a first sounding packet of the one or more sounding packets, where the one or more first values are grouped in a first subset of the plurality of subsets: and may acquire one or more second values of the plurality of values associated with a second sounding packet of the one or more sounding packets, where the one or more second values are grouped in a second subset of the plurality of subsets.

In some implementations, the values grouped in a first subset of the plurality of subsets may indicate CFRs associated with one or more first tones of the K tones and the values grouped in a second subset of the plurality of subsets may indicate CFRs associated with one or more second tones of the K tones that are different than the one or more first tones. For example, the one or more first tones may represent a first decimated subset of the K tones and the one or more second tones may represent a second decimated subset of the K tones. Alternatively, or in addition, the one or more first tones may span a first sub-band within the bandwidth of the wireless channel and the one or more second tones may span a second sub-band within the bandwidth of the wireless channel.

In some implementations, the values grouped in a first subset of the plurality of subsets may indicate CFRs associated with one or more first transmit antennas of the M transmit antennas and the values grouped in a second subset of the plurality of subsets may indicate CFRs associated with one or more second transmit antennas of the M transmit antennas that are different than the one or more first transmit antennas. In some other implementations, the values grouped in a first subset of the plurality of subsets may indicate CFRs associated with one or more first receive antennas of the N receive antennas and the values grouped in a second subset of the plurality of subsets may indicate CFRs associated with one or more second receive antennas of the N receive antennas that are different than the one or more first receive antennas.

In some implementations, the values grouped in a first subset of the plurality of subsets may represent in-phase (I) components of one or more CFRs and the values grouped in a second subset of the plurality of subsets may represent quadrature (Q) components of the one or more CFRs. In some other implementations, the values grouped in a first subset of the plurality of subsets may represent amplitude components of one or more CFRs and the values grouped in a second subset of the plurality of subsets may represent phase components of the one or more CFRs.

The wireless communication device transmits one or more CSI report frames each carrying a respective subset of values of the plurality of subsets (1406). In some implementations, each of the one or more CSI report frames may further carry grouping information indicating the subset of values carried in the CSI report frame. In some implementations, the wireless communication device may further receive a CSI request indicating the respective subset of values for transmission in each of the one or more CSI report frames.

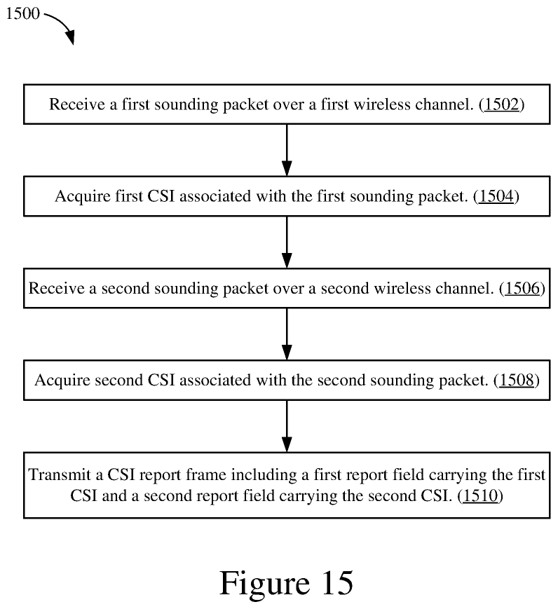

FIG. 15 shows an illustrative flowchart depicting an example wireless communication operation 1500. The example operation 1500 may be performed by a wireless communication device such as any of the RX devices 720, 820, 920, or 1020 of FIGS. 7-10, respectively.

The wireless communication device receives a first sounding packet over a first wireless channel (1502). The wireless communication device further acquires first CSI associated with the first sounding packet (1504). The wireless communication device receives a second sounding packet over a second wireless channel (1506). The wireless communication device further acquires second CSI associated with the second sounding packet (1508). The wireless communication device transmits a CSI report frame including a first report field carrying the first CSI and a second report field carrying the second CSI (1510).

In some implementations, the first and second sounding packets may be received from a transmitting device. In such implementations, the wireless communication device may further receive a trigger frame from the transmitting device, where the CSI report frame is transmitted to the transmitting device responsive to the trigger frame. In some other implementations, the first sounding packet may be received from a first transmitting device and the second sounding packet may be received from a second transmitting device that is different than the first transmitting device. In such implementations, the wireless communication device may further receive a trigger frame from an initiator device that is different than each of the first and second transmitting devices, where the CSI report frame is transmitted to the initiator device responsive to the trigger frame.

In some implementations, the first CSI report frame may further include a first control field carrying metadata associated with the first CSI and may include a second control field carrying metadata associated with the second CSI. Example metadata may include, but is not limited to, a vendor ID associated with the wireless communication device, a MAC address of a transmitting device, an indication of whether CSI was successfully acquired, a grouping of CFR values, a type of preamble associated with received sounding packets, a per-chain RSSI, a CFO, a per-chain AGC, a receive chain mask, a timestamp associated with a received sounding packet, per-chain phase information, a type of modulation associated with received sounding packets, an indication of whether received sounding packets conform to a multi-user format, and a number of bits associated with each CFR value.

In some implementations, the CSI report frame may be a management frame having a frame body that includes a first IE and a second IE, where the first IE includes the first control field and the first report field, and where the second IE includes the second control field and the second report field. In some other implementations, the CSI report frame may be a management frame having a frame body that includes the first control field immediately followed by the first report field and includes the second control field immediately followed by the second report field, where the first control field further carries length information indicating a length of the first report field, and where the second control field further carries length information indicating a length of the second report field.

In some implementations, the CSI report frame may be a management frame having a frame body that includes the first control field immediately followed by the first report field and includes the second control field immediately followed by the second report field, where the CSI report frame further includes a first delimiter immediately preceding the first control field and a second delimiter immediately preceding the second control field. In some other implementations, the CSI report frame may be a management frame having a frame body that includes the first control field immediately followed by the first report field and includes the second control field immediately followed by the second report field, where the CSI report frame further includes a first delimiter immediately following the first report field and a second delimiter immediately following the second report field

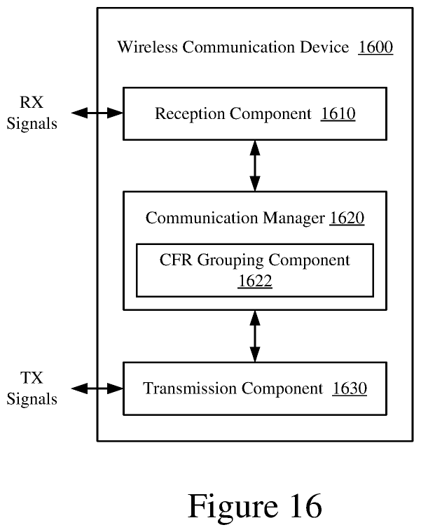

FIG. 16 shows a block diagram of an example wireless communication device 1600. In some implementations, the wireless communication device 1600 may be configured to perform the process 1400 described above with reference to FIG. 14. The wireless communication device 1600 can be an example implementation of any of the RX devices 720, 820, 920, or 1020 of FIGS. 7-10, respectively. More specifically, the wireless communication device 1600 can be a chip, SoC, chipset, package or device that includes at least one processor and at least one modem (for example, a Wi-Fi (IEEE 802.11) modem or a cellular modem).

The wireless communication device 1600 includes a reception component 1610, a communication manager 1620, and a transmission component 1630. The communication manager 1620 further includes a CFR grouping component 1622. Portions of the CFR grouping component 1622 may be implemented at least in part in hardware or firmware. In some implementations, the CFR grouping component 1622 is implemented at least in part as software stored in a memory (such as the memory 240 of FIG. 2 or the memory 330 of FIG. 3). For example, portions of the CFR grouping component 1622 can be implemented as non-transitory instructions (or “code”) executable by a processor (such as the processor 220 of FIG. 2 or the processor 320 of FIG. 3) to perform the functions or operations of the respective component.

The reception component 1610 is configured to receive RX signals from one or more other wireless communication devices. In some implementations, the reception component 1610 may receive one or more sounding packets, over a wireless channel, from a transmitting device. The communication manager 1620 is configured to manage wireless communications with one or more other wireless communication devices. In some implementations, the CFR grouping component 1622 may acquire CSI associated with the one or more sounding packets, where the CSI includes a set of values grouped into a plurality of subsets according to a number (M) of transmit antennas of the transmitting device, a number (N) of receive antennas of the wireless communication device, or a number (K) of tones spanning a bandwidth of the wireless channel, where each of the values indicates a CFR associated with a respective one of the M transmit antennas, a respective one of the N receive antennas, and a respective one of the K tones. The transmission component 1630 is configured to transmit TX signals to one or more other wireless communication devices. In some implementations, the transmission component 1630 may transmit one or more CSI report frames each carrying a respective subset of values of the plurality of subsets.

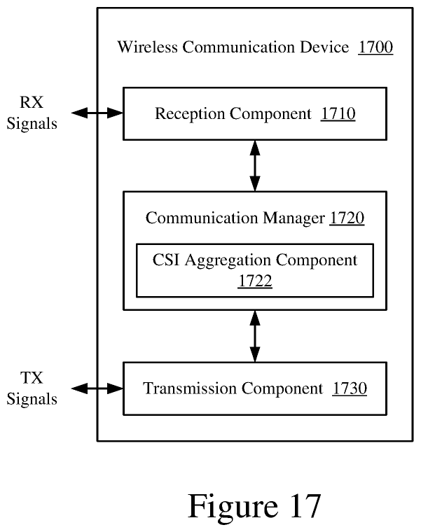

FIG. 17 shows a block diagram of an example wireless communication device 1700. In some implementations, the wireless communication device 1700 may be configured to perform the process 1500 described above with reference to FIG. 15. The wireless communication device 1700 can be an example implementation of any of the RX devices 720, 820, 920, or 1020 of FIGS. 7-10, respectively. More specifically, the wireless communication device 1700 can be a chip, SoC, chipset, package or device that includes at least one processor and at least one modem (for example, a Wi-Fi (IEEE 802.11) modem or a cellular modem).

The wireless communication device 1700 includes a reception component 1710, a communication manager 1720, and a transmission component 1730. The communication manager 1720 further includes a CSI aggregation component 1722. Portions of the CSI aggregation component 1722 may be implemented at least in part in hardware or firmware. In some implementations, the CSI aggregation component 1722 is implemented at least in part as software stored in a memory (such as the memory 240 of FIG. 2 or the memory 330 of FIG. 3). For example, portions of the CSI aggregation component 1722 can be implemented as non-transitory instructions (or “code”) executable by a processor (such as the processor 220 of FIG. 2 or the processor 320 of FIG. 3) to perform the functions or operations of the respective component.

The reception component 1710 is configured to receive RX signals from one or more other wireless communication devices. In some implementations, the reception component 1710 may receive a first sounding packet over a first wireless channel and may further receive a second sounding packet over a second wireless channel. The communication manager 1620 is configured to manage wireless communications with one or more other wireless communication devices. In some implementations, the CSI aggregation component 1722 may acquire first CSI associated with the first sounding packet and may acquire second CSI associated with the second sounding packet. The transmission component 1630 is configured to transmit TX signals to one or more other wireless communication devices. In some implementations, the transmission component 1630 may transmit a CSI report frame including a first report field carrying the first CSI and a second report field carrying the second CSI.

Implementation examples are described in the following numbered clauses:

1. A method for wireless communication by a wireless communication device, including:
receiving one or more sounding packets, over a wireless channel, from a transmitting device:
acquiring channel state information (CSI) associated with the one or more sounding packets, the CSI including a set of values grouped into a plurality of subsets according to a number (M) of transmit antennas of the transmitting device, a number (N) of receive antennas of the wireless communication device, or a number (K) of tones spanning a bandwidth of the wireless channel, each of the values indicating a channel frequency response (CFR) associated with a respective one of the M transmit antennas, a respective one of the N receive antennas, and a respective one of the K tones; and
transmitting one or more CSI report frames each carrying a respective subset of values of the plurality of subsets.

2. The method of clause 1, where the values grouped in a first subset of the plurality of subsets indicate CFRs associated with one or more first tones of the K tones and the values grouped in a second subset of the plurality of subsets indicate CFRs associated with one or more second tones of the K tones that are different than the one or more first tones.

3. The method of any of clauses 1 or 2, where the one or more first tones represent a first decimated subset of the K tones and the one or more second tones represent a second decimated subset of the K tones.

4. The method of any of clauses 1-3, where the one or more first tones span a first sub-band within the bandwidth of the wireless channel and the one or more second tones span a second sub-band within the bandwidth of the wireless channel.

5 The method of any of clauses 1-4, where the values grouped in a first subset of the plurality of subsets indicate CFRs associated with one or more first transmit antennas of the M transmit antennas and the values grouped in a second subset of the plurality of subsets indicate CFRs associated with one or more second transmit antennas of the M transmit antennas that are different than the one or more first transmit antennas.

6. The method of any of clauses 1-5, where the values grouped in a first subset of the plurality of subsets indicate CFRs associated with one or more first receive antennas of the N receive antennas and the values grouped in a second subset of the plurality of subsets indicate CFRs associated with one or more second receive antennas of the N receive antennas that are different than the one or more first receive antennas.

7. The method of any of clauses 1-6, where the values grouped in a first subset of the plurality of subsets represent in-phase (I) components of one or more CFRs and the values grouped in a second subset of the plurality of subsets represent quadrature (Q) components of the one or more CFRs.

8 The method of any of clauses 1-6, where the values grouped in a first subset of the plurality of subsets represent amplitude components of one or more CFRs and the values grouped in a second subset of the plurality of subsets represent phase components of the one or more CFRs.

9. The method of any of clauses 1-8, where each of the plurality of values is associated with the same sounding packet of the one or more sounding packets.

10. The method of any of clauses 1-8, where the acquiring of the CSI includes:
acquiring one or more first values of the plurality of values associated with a first sounding packet of the one or more sounding packets, the one or more first values being grouped in a first subset of the plurality of subsets; and
acquiring one or more second values of the plurality of values associated with a second sounding packet of the one or more sounding packets, the one or more second values being grouped in a second subset of the plurality of subsets.

11. The method of any of clauses 1-10, where each of the one or more CSI report frames further carries grouping information indicating the subset of values carried in the CSI report frame.

12. The method of any of clauses 1-11, further including:
receiving a CSI request indicating the respective subset of values for transmission in each of the one or more CSI report frames.

13. A wireless communication device, including:
an interface configured to:
   receive one or more sounding packets, over a wireless channel,
from a transmitting device; and
a processing system configured to:
   acquire channel state information (CSI) associated with the one or more sounding packets, the CSI including a set of values grouped into a plurality of subsets according to a number (M) of transmit antennas of the transmitting device, a number (N) of receive antennas of the wireless communication device, or a number (K) of tones spanning a bandwidth of the wireless channel, each of the values indicating a channel frequency response (CFR) associated with a respective one of the M transmit antennas, a respective one of the N receive antennas, and a respective one of the K tones:
the interface being further configured to transmit one or more CSI report frames each carrying a respective subset of values of the plurality of subsets.

14. The wireless communication device of clause 13, where the values grouped in a first subset of the plurality of subsets indicate CFRs associated with one or more first tones of the K tones and the values grouped in a second subset of the plurality of subsets indicate CFRs associated with one or more second tones of the K tones that are different than the one or more first tones.

15. The wireless communication device of any of clauses 13 or 14, where the values grouped in a first subset of the plurality of subsets indicate CFRs associated with one or more first transmit antennas of the M transmit antennas and the values grouped in a second subset of the plurality of subsets indicate CFRs associated with one or more second transmit antennas of the M transmit antennas that are different than the one or more first transmit antennas.

16. The wireless communication device of any of clauses 13-15, where the values grouped in a first subset of the plurality of subsets indicate CFRs associated with one or more first receive antennas of the N receive antennas and the values grouped in a second subset of the plurality of subsets indicate CFRs associated with one or more second receive antennas of the N receive antennas that are different than the one or more first receive antennas.

17. The wireless communication device of any of clauses 13-16, where the values grouped in a first subset of the plurality of subsets represent in-phase (I) components of one or more CFRs and the values grouped in a second subset of the plurality of subsets represent quadrature (Q) components of the one or more CFRs.

18. The wireless communication device of any of clauses 13-17, where the values grouped in a first subset of the plurality of subsets represent amplitude components of one or more CFRs and the values grouped in a second subset of the plurality of subsets represent phase components of the one or more CFRs.

19. A method for wireless communication performed by a wireless communication device, including:
receiving a first sounding packet over a first wireless channel;
acquiring first channel state information (CSI) associated with the first sounding packet;
receiving a second sounding packet over a second wireless channel;
acquiring second CSI associated with the second sounding packet; and
transmitting a CSI report frame including a first report field carrying the first CSI and a second report field carrying the second CSI.

20. The method of clause 19, where the first and second sounding packets are received from a transmitting device.

21. The method of any of clauses 19 or 20, further including:
receiving a trigger frame from the transmitting device, the CSI report frame being transmitted to the transmitting device responsive to the trigger frame.

22. The method of clause 19, where the first sounding packet is received from a first transmitting device and the second sounding packet is received from a second transmitting device that is different than the first transmitting device.

23. The method of any of clauses 19 or 22, further including:
receiving a trigger frame from an initiator device that is different than each of the first and second transmitting devices, the CSI report frame being transmitted to the initiator device responsive to the trigger frame.

24. The method of any of clauses 19-23, where the CSI report frame further includes a first control field carrying metadata associated with the first CSI and includes a second control field carrying metadata associated with the second CSI.

25. The method of any of clauses 19-24, where the metadata includes at least one of a vendor identifier (ID) associated with the wireless communication device, a medium access control (MAC) address of a transmitting device, an indication of whether CSI was successfully acquired, a grouping of channel frequency response (CFR) values, a type of preamble associated with received sounding packets, a per-chain receive signal strength indication (RSSI), a carrier frequency offset (CFO), a per-chain automatic gain control (AGC), a receive chain mask, a timestamp associated with a received sounding packet, per-chain phase information, a type of modulation associated with received sounding packets, an indication of whether received sounding packets conform to a multi-user format, and a number of bits associated with each CFR value.

26. The method of any of clauses 19-25, where the CSI report frame is a management frame having a frame body that includes a first information element (IE) and a second IE, the first IE including the first control field and the first report field, the second IE including the second control field and the second report field.

27. The method of any of clauses 19-25, where the CSI report frame is a management frame having a frame body that includes the first control field immediately followed by the first report field and includes the second control field immediately followed by the second report field, the first control field further carrying length information indicating a length of the first report field, the second control field further carrying length information indicating a length of the second report field.

28. The method of any of clauses 19-25, where the CSI report frame is a management frame having a frame body that includes the first control field immediately followed by the first report field and includes the second control field immediately followed by the second report field, the CSI report frame further including one or more delimiters separating the first report field from the second control field.

29. A wireless communication device, including:
an interface configured to:
   receive a first sounding packet over a first wireless channel; and
   receive a second sounding packet over a second wireless channel: and
a processing system configured to:
   acquire first channel state information (CSI) associated with the first sounding packet; and
   acquire second CSI associated with the second sounding packet:
the interface being further configured to transmit a CSI report frame including a first report field carrying the first CSI and a second report field carrying the second CSI.

30. The wireless communication device of clause 29, where the first and second sounding packets are received from the same transmitting device.

31. The wireless communication device of clause 29, where the first sounding packet is received from a first transmitting device and the second sounding packet is received from a second transmitting device that is different than the first transmitting device.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication performed by a wireless communication device, comprising:
receiving one or more sounding packets, over a wireless channel, from a transmitting device;
acquiring channel state information (CSI) associated with the one or more sounding packets, the CSI including a set of values grouped into a plurality of subsets according to a number (M) of transmit antennas of the transmitting device, a number (N) of receive antennas of the wireless communication device, or a number (K) of tones spanning a bandwidth of the wireless channel, each of the values indicating a channel frequency response (CFR) associated with a respective one of the M transmit antennas, a respective one of the N receive antennas, and a respective one of the K tones; and
transmitting one or more CSI report frames each carrying a respective subset of values of the plurality of subsets.

2. The method of claim 1, wherein the values grouped in a first subset of the plurality of subsets indicate CFRs associated with one or more first tones of the K tones and the values grouped in a second subset of the plurality of subsets indicate CFRs associated with one or more second tones of the K tones that are different than the one or more first tones.

3. The method of claim 2, wherein the one or more first tones represent a first decimated subset of the K tones and the one or more second tones represent a second decimated subset of the K tones.

4. The method of claim 2, wherein the one or more first tones span a first sub-band within the bandwidth of the wireless channel and the one or more second tones span a second sub-band within the bandwidth of the wireless channel.

5. The method of claim 1, wherein the values grouped in a first subset of the plurality of subsets indicate CFRs associated with one or more first transmit antennas of the M transmit antennas and the values grouped in a second subset of the plurality of subsets indicate CFRs associated with one or more second transmit antennas of the M transmit antennas that are different than the one or more first transmit antennas.

6. The method of claim 1, wherein the values grouped in a first subset of the plurality of subsets indicate CFRs associated with one or more first receive antennas of the N receive antennas and the values grouped in a second subset of the plurality of subsets indicate CFRs associated with one or more second receive antennas of the N receive antennas that are different than the one or more first receive antennas.

7. The method of claim 1, wherein the values grouped in a first subset of the plurality of subsets represent in-phase (I) components of one or more CFRs and the values grouped in a second subset of the plurality of subsets represent quadrature (Q) components of the one or more CFRs.

8. The method of claim 1, wherein the values grouped in a first subset of the plurality of subsets represent amplitude components of one or more CFRs and the values grouped in a second subset of the plurality of subsets represent phase components of the one or more CFRs.

9. The method of claim 1, wherein each of the plurality of values is associated with the same sounding packet of the one or more sounding packets.

10. The method of claim 1, wherein the acquiring of the CSI comprises:
acquiring one or more first values of the plurality of values associated with a first sounding packet of the one or more sounding packets, the one or more first values being grouped in a first subset of the plurality of subsets; and
acquiring one or more second values of the plurality of values associated with a second sounding packet of the one or more sounding packets, the one or more second values being grouped in a second subset of the plurality of subsets.

11. The method of claim 1, wherein each of the one or more CSI report frames further carries grouping information indicating the subset of values carried in the CSI report frame.

12. The method of claim 1, further comprising:
receiving a CSI request indicating the respective subset of values for transmission in each of the one or more CSI report frames.

13. A wireless communication device, comprising:
an interface configured to:
receive one or more sounding packets, over a wireless channel, from a transmitting device; and
a processing system configured to:
acquire channel state information (CSI) associated with the one or more sounding packets, the CSI including a set of values grouped into a plurality of subsets according to a number (M) of transmit antennas of the transmitting device, a number (N) of receive antennas of the wireless communication device, or a number (K) of tones spanning a bandwidth of the wireless channel, each of the values indicating a channel frequency response (CFR) associated with a respective one of the M transmit antennas, a respective one of the N receive antennas, and a respective one of the K tones;
the interface being further configured to transmit one or more CSI report frames each carrying a respective subset of values of the plurality of subsets.

14. The wireless communication device of claim 13, wherein the values grouped in a first subset of the plurality of subsets indicate CFRs associated with one or more first tones of the K tones and the values grouped in a second subset of the plurality of subsets indicate CFRs associated with one or more second tones of the K tones that are different than the one or more first tones.

15. The wireless communication device of claim 13, wherein the values grouped in a first subset of the plurality of subsets indicate CFRs associated with one or more first transmit antennas of the M transmit antennas and the values grouped in a second subset of the plurality of subsets indicate CFRs associated with one or more second transmit antennas of the M transmit antennas that are different than the one or more first transmit antennas.

16. The wireless communication device of claim 13, wherein the values grouped in a first subset of the plurality of subsets indicate CFRs associated with one or more first receive antennas of the N receive antennas and the values grouped in a second subset of the plurality of subsets indicate CFRs associated with one or more second receive antennas of the N receive antennas that are different than the one or more first receive antennas.

17. The wireless communication device of claim 13, wherein the values grouped in a first subset of the plurality of subsets represent in-phase (I) components of one or more CFRs and the values grouped in a second subset of the plurality of subsets represent quadrature (Q) components of the one or more CFRs.

18. The wireless communication device of claim 13, wherein the values grouped in a first subset of the plurality of subsets represent amplitude components of one or more CFRs and the values grouped in a second subset of the plurality of subsets represent phase components of the one or more CFRs.

19. A method for wireless communication performed by a wireless communication device, comprising:
receiving a first sounding packet over a first wireless channel;
acquiring first channel state information (CSI) associated with the first sounding packet;
receiving a second sounding packet over a second wireless channel;
acquiring second CSI associated with the second sounding packet; and
transmitting a CSI report frame including a first report field carrying the first CSI and a second report field carrying the second CSI.

20. The method of claim 19, wherein the first and second sounding packets are received from a transmitting device.

21. The method of claim 20, further comprising:
receiving a trigger frame from the transmitting device, the CSI report frame being transmitted to the transmitting device responsive to the trigger frame.

22. The method of claim 19, wherein the first sounding packet is received from a first transmitting device and the second sounding packet is received from a second transmitting device that is different than the first transmitting device.

23. The method of claim 22, further comprising:
receiving a trigger frame from an initiator device that is different than each of the first and second transmitting devices, the CSI report frame being transmitted to the initiator device responsive to the trigger frame.

24. The method of claim 19, wherein the CSI report frame further includes a first control field carrying metadata associated with the first CSI and includes a second control field carrying metadata associated with the second CSI.

25. The method of claim 24, wherein the metadata includes at least one of a vendor identifier (ID) associated with the wireless communication device, a medium access control (MAC) address of a transmitting device, an indication of whether CSI was successfully acquired, a grouping of channel frequency response (CFR) values, a type of preamble associated with received sounding packets, a per-chain receive signal strength indication (RSSI), a carrier frequency offset (CFO), a per-chain automatic gain control (AGC), a receive chain mask, a timestamp associated with a received sounding packet, per-chain phase information, a type of modulation associated with received sounding packets, an indication of whether received sounding packets conform to a multi-user format, and a number of bits associated with each CFR value.

26. The method of claim 24, wherein the CSI report frame is a management frame having a frame body that includes a first information element (IE) and a second IE, the first IE including the first control field and the first report field, the second IE including the second control field and the second report field.

27. The method of claim 24, wherein the CSI report frame is a management frame having a frame body that includes the first control field immediately followed by the first report field and includes the second control field immediately followed by the second report field, the first control field further carrying length information indicating a length of the first report field, the second control field further carrying length information indicating a length of the second report field.

28. The method of claim 24, wherein the CSI report frame is a management frame having a frame body that includes the first control field immediately followed by the first report field and includes the second control field immediately followed by the second report field, the CSI report frame further including one or more delimiters separating the first report field from the second control field.

29. A wireless communication device, comprising:
an interface configured to:
receive a first sounding packet over a first wireless channel; and
receive a second sounding packet over a second wireless channel; and
a processing system configured to:
acquire first channel state information (CSI) associated with the first sounding packet; and
acquire second CSI associated with the second sounding packet; and
the interface being further configured to transmit a CSI report frame including a first report field carrying the first CSI and a second report field carrying the second CSI.

30. The wireless communication device of claim 29, wherein the first and second sounding packets are received from the same transmitting device.

31. The wireless communication device of claim 29, wherein the first sounding packet is received from a first transmitting device and the second sounding packet is received from a second transmitting device that is different than the first transmitting device.
